(19) United States
(12) Patent Application Publication
(10) Pub. No.: US 2026/0222998 A1
(43) Pub. Date: Jul. 30, 2026

(54) MEASUREMENT BY LOW POWER WAKE-UP SIGNALING

(71) Applicant: INTEL CORPORATION, Santa Clara, CA (US)

(72) Inventors: Yi WANG, Santa Clara, CA (US); Yingyang LI, Santa Clara, CA (US); Gang XIONG, Portland, OR (US); Debdeep CHATTERJEE, San Jose, CA (US)

(73) Assignee: INTEL CORPORATION, Santa Clara, CA (US)

(21) Appl. No.: 19/146,916

(22) PCT Filed: Dec. 20, 2023
(86) PCT No.: PCT/US2023/085046

§ 371 Date: Jul. 9, 2025

Related U.S. Application Data
(60) Provisional application No. 63/485,509, filed on Feb. 16, 2023.

(30) Foreign Application Priority Data
Mar. 24, 2023 (WO) PCT/CN2023/083797

(51) Int. Cl. H04W 52/02; H04B 7/06; H04B 17/309; H04B 17/318; H04W 24/08; H04W 24/10; H04W 56/00

(52) U.S. Cl. CPC H04W 52/0235; H04B 7/0626; H04B 17/328; H04B 17/346; H04W 24/08; H04W 24/10; H04W 56/0015

(57) ABSTRACT

The present disclosure is related to wireless communications, cellular networks, and communication system implementations, and in particular, to technologies and techniques for performing low power wake-up signal (LP-WUS) measurements. In particular, the present disclosure describes LP-WUS and wake-up channel structures and designs for LP-WUS based radio resource management (RRM) measurement, radio link monitoring (RLM) measurement, and beam failure detection (BFD) measurement, as well as mechanisms for activation and deactivation of LP-WUS monitoring, and other LP-WUS aspects.

### CROSS REFERENCE TO RELATED APPLICATION

The present application claims priority to U.S. Provisional App. No. 63/485,509 filed Feb. 16, 2023 (“'509”) and International App. No. PCT/CN2023/083797 filed Mar. 24, 2023 (“'797”), the contents of each of which are hereby incorporated by reference in their entireties.

### BACKGROUND

Third generation partnership project (3GPP) release (Rel-)15 introduced a wake-up signal (WUS) feature, which is based on a paging signal sent over a physical downlink shared channel (PDSCH) that “wakes up” a user equipment (UE) from an idle state so that the UE can prepare to receive data. The WUS reduces power consumption and improves battery life by allowing the UE to remain in the idle state until required, thereby reducing the UE's power/energy consumption.

### BRIEF DESCRIPTION OF THE DRAWINGS

In the drawings, which are not necessarily drawn to scale, like numerals may describe similar components in different views. Like numerals having different letter suffixes may represent different instances of similar components. Some examples are illustrated by way of example, and not limitation, in the figures of the accompanying drawings in which: FIG. 1 depicts example operations of a main radio (MR) and low-power wake-up radio (LP-WUR) in a user equipment (UE); FIG. 2 depicts an example criteria evaluation periods for the MR; FIG. 3 depicts an example evaluation periods for the LP-WUR; FIG. 4 depicts an example network architecture;

FIG. 5 depicts an example wireless network; FIG. 6 depicts example hardware resources; and FIGS. 7 and 8 depict example processes for practicing the various embodiments discussed herein.

### DETAILED DESCRIPTION

### 1. Low-Power Wakeup Signal Aspects

The present disclosure is generally related to cellular communications networks and technologies, network topologies, and communication system implementations, and in particular, to techniques and technologies for low power wake-up signal (LP-WUS) measurement.

Fifth generation systems (5GS) are designed and developed targeting for both mobile telephony and vertical use cases. Besides latency, reliability, and availability, UE energy efficiency is also critical to fifth generation (5G). Currently, 5G devices may have to be recharged per week or day, depending on individual's usage time. In general, 5G devices consume tens of milliwatts in RRC idle/inactive state and hundreds of milliwatts in RRC connected state. The idle/inactive state power consumption is based at least in part on the fact that the 5G devices carry out periodic measurements and check for potential paging messages. Designs to prolong battery life is a necessity for improving energy efficiency as well as for better user experience.

Energy efficiency is even more critical for UEs without a continuous energy source (e.g., UEs using small rechargeable and/or single coin cell batteries). Among vertical use cases, sensors and actuators are deployed extensively for monitoring, measuring, charging, and/or for other purposes. Generally, their batteries are not rechargeable and expected to last at least few years as described in 3GPP technical reference (TR) 38.875. Other use cases include wearable devices/UEs. Examples of wearables include smart watches, rings, eHealth related devices, and medical monitoring devices. With typical battery capacity, it is challenging to sustain up to 1-2 weeks as required for many use cases.

The power consumption depends on the configured length of wake-up periods (e.g., paging cycle). To meet the battery life requirements mentioned previously, extended discontinuous reception (eDRX) cycle with large value is expected to be used, resulting in high latency, which is not suitable for such services with requirements of both long battery life and low latency. For example, in fire detection and extinguishment use cases, fire shutters shall be closed and fire sprinklers shall be turned on by the actuators within 1 to 2 seconds from the time the fire is detected by sensors; a long eDRX cycle cannot meet the delay requirements. eDRX is apparently not suitable for latency-critical use cases. Therefore, ultra-low power mechanism that can support low latency (e.g., lower than eDRX latency) are currently being studied and/or developed.

Currently, UEs need to periodically wake up once per discontinuous reception (DRX) cycle, which dominates the power consumption in periods with no signalling or data traffic. If UEs are able to wake up only when they are triggered (e.g., via paging), power consumption could be dramatically reduced. This can be achieved by using a WUS to trigger the main radio and a separate radio that has the ability to monitor WUS with low power or ultra-low power consumption. Here, the main radio works for data transmission and reception, which can be turned off or set to deep sleep unless it is turned on. The power consumption for monitoring WUS depends on the WUS design and the hardware module of the wake-up receiver used for signal detecting and processing.

FIG. 1 illustrates an example usage of a main radio (MR) 105 (also referred to herein as “primary radio 105”, “main receiver 105”, or “main Rx 105”) and a low power wake-up signal radio (LP-WUR) 110 (also referred to as “LR 110”) in a UE 402. In some examples, the UE 402 is a reduced capability (RedCap) UE. Additionally or alternatively, the UE 402 can be implemented or embodided as any low-power and/or power-sensitive, small form-factor devices including, for example, IoT devices (e.g., industrial sensors, controllers, actuators, and/or the like), wearables, and/or the like. Additionally or alternatively, the UE 402 can be implemented or embodided as any other device(s), such as extended reality (XR) devices, smart glasses, smartphones, smart appliances, robots, drones, and/or any other device(s), such as any of those mentioned herein.

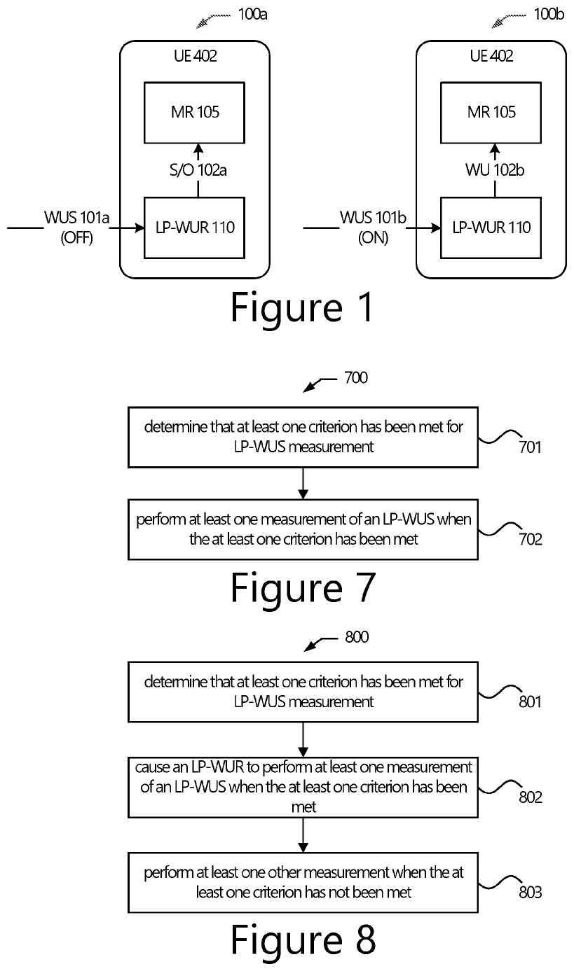

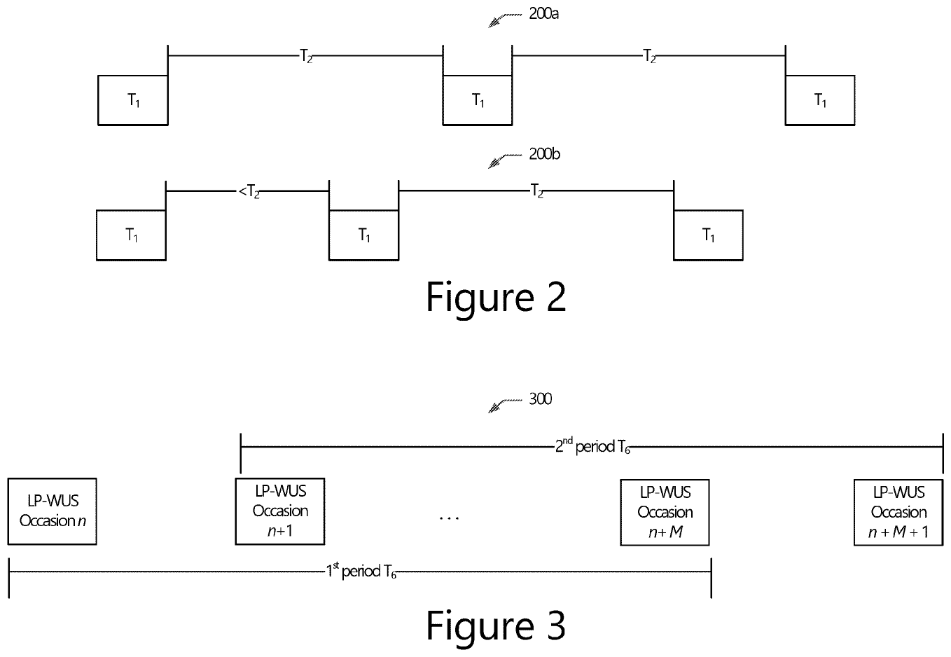

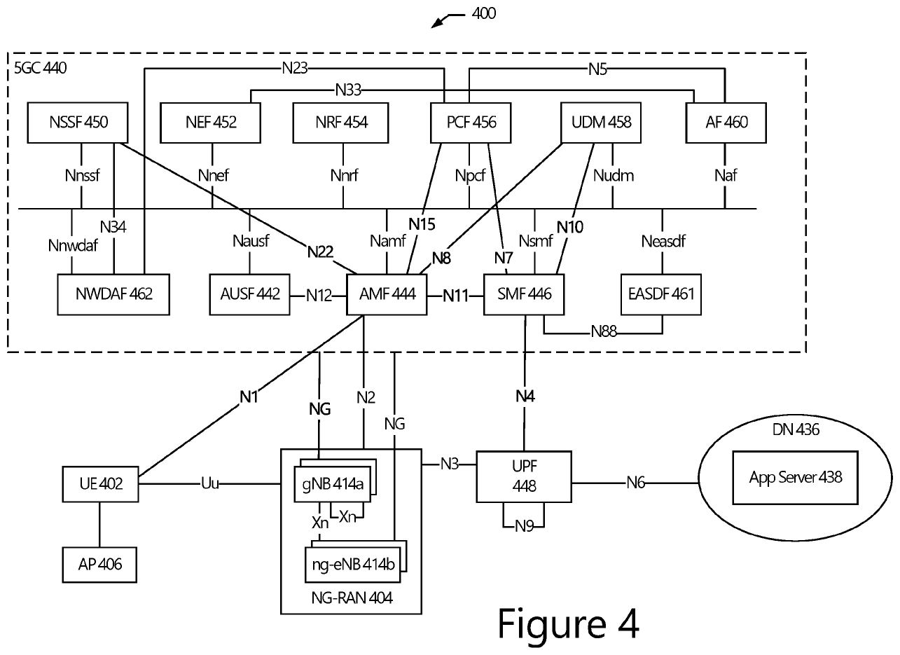

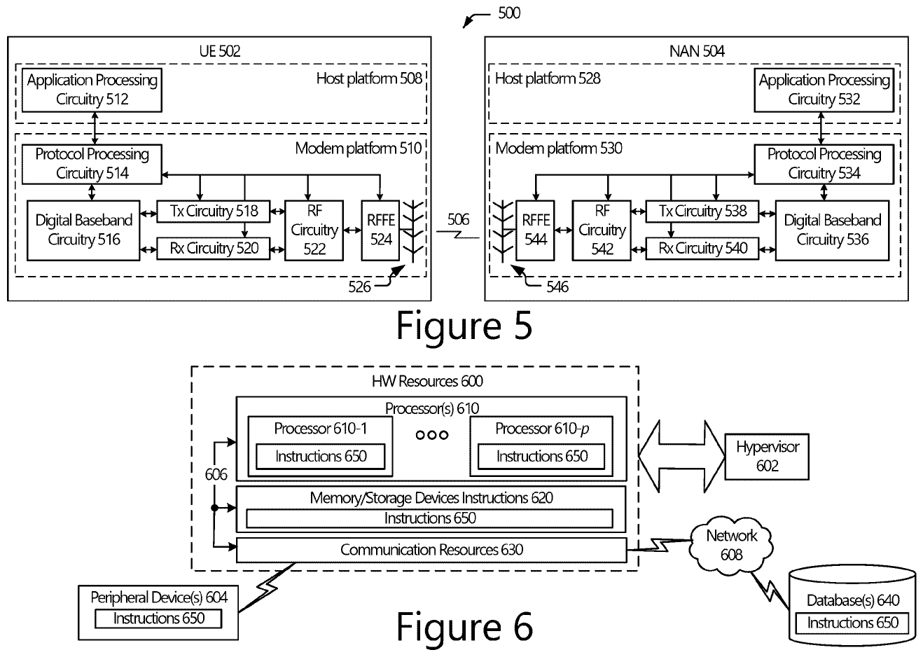

The MR 105 comprises transmitter (Tx)/receiver (Rx) circuitry (or a Tx/Rx module) operating for 5G/new radio (NR) signals/channels apart from signals/channel related to low-power wake-up/LP-WUS. In some examples, the MR 105 is the same or similar as, or otherwise corresponds to, the model platform 510 of FIG. 5.

LP-WUR (LR) 110 comprises at least Rx circuitry (or at least an Rx module) operating for receiving and/or processing signals/channel(s) related to low-power wake-up/LP-WUS. The LP-WUR 110 can be implemented or embodided according to any of the following architectures: on-off keying (OOK) modulation receiver (Rx) architectures (e.g., architecture with radiofrequency (RF) envelope detection, heterodyne architecture with or without intermediate frequency (IF) envelope detection, homodyne/zero-IF architecture with or without baseband envelope detection, and/or the like); frequency shift keying (FSK) Rx architectures (e.g., FSK Rx with or without parallel OOK Rxs and a comparator circuit(s) (e.g., parallel homodyne/zero IF architecture, parallel heterodyne/IF envelope detection architecture, and/or the like), FSK LP-WUS Rx with frequency modulation (FM)-amplitude modulation (AM) detector (or an FM detector), FSK LP-WUS Rx with FM-AM detector by using a frequency discriminator, homodyne architecture with frequency to amplitude conversion, heterodyne architecture with frequency to amplitude conversion, and/or the like); orthogonal frequency division multiple access (OFDMA)-based signals/channels used for OOK/ASK and FSK modulated LP-WUS; time domain correlators (without FFT or with FFT); Goertzel filters; and/or the like. Additional or alternative aspects of the LP-WUR 110 architectures are discussed in more detail in 3GPP TR 38.869 (“[TR38869]”).

Scenario 100a shows the UE 402 in an OFF and/or deep sleep state. In scenario 100a, the LR 110 receives a WUS 101a that is to place the UE 402 (or the MR 105) in the OFF and/or deep sleep state. The WUS 101a is an “OFF” signal or “no wake up” signal (or carries/encodes an “OFF” or “no wake up” indicator). The WUS 101a can be sent during a DRX/eDRX off duration period or during a DRX/eDRX on duration period when there is no data for the UE 402. Based on receipt of the WUS 101a, the LR 110 provides a sleep/off signal/indicator (S/O) 102a to the MR 105. Based on the S/O 102a, the MR 105 enters a (deep) sleep state or shuts off. Additionally or alternatively, the S/O 102a causes the MR 105 to enter a power saving state.

Scenario 100b shows the UE 402 in an ON or active state. In scenario 100b, the LR 110 receives a WUS 101b that is to place the MR 105 in an ON state, an active state, or an awake state. The WUS 101a can be sent during a DRX/eDRX on duration period when there is data for the UE 402. Based on receipt of the WUS 101b, the LR 110 provides a wake-up signal/indicator (WU) 102b to the MR 105. Based on the WU 102b, the MR 105 turns on and/or enters an active state. In some implementations, the WUS 101a, 101b (collectively referred to as “WUS 101”) can also be referred to as a “wake-up indication”. Additionally or alternatively, the WUS 101 can have a waveform and/or physical design as discussed in [TR38869].

The LR 110 is independent of the MR 105, such that the MR 105 can be powered off while the LR 110 is active and searching for a potential LP-WUS 101. In the power saving state (e.g., the OFF or sleep state in 100a), if no WUS 101 is received by the LR 110, the MR 105 stays in the OFF state for deep sleep. On the other hand, if a WUS 101 is received by the LR 110, the LR 110 will trigger 102b to turn on the MR 105. In the latter case, since MR 105 is active, the LR 110 can be turned off.

The WUS/channel 101 can be used for triggering of signal reception (Rx)/transmission (Tx) by the MR 105. The WUS/channel 101 can also be used for measurement, such as radio resource monitoring (RRM) measurement for serving cell or neighbor cell(s), radio link monitoring (RLM) measurement, beam failure detection (BFD), and/or the like. With the measurement by WUS/channel 101, the MR 105 can be turned off with larger periodicity to further reduce power consumption at the UE 402.

In the present disclosure, mechanisms for measurement based on LP-WUS are presented. The present disclosure provides technologies, techniques, and designs for the WUS/channel 101. In particular, systems and methods for LP-WUS measurement are discussed herein.

The LP-WUS 101 can serve at least one of the following purposes: LP-WUS 101 can be used for cell selection (e.g., UE 402 may identify individual cells and perform RRM measurement(s) based on the LP-WUS); LP-WUS 101 can be used for radio link monitoring (RLM); LP-WUS 101 can be used for beam management (e.g., beam failure detection (BFD) and/or the like); LP-WUS 101 can be used to determine paging reception; LP-WUS 101 can be used to determine SIB reception; and/or LP-WUS 101 can be used to obtain synchronization.

To serve at least one of these purposes, a single LP-WUS 101 or multiple different types of LP-WUS 101 can be supported. In an example, a single LP-WUS configuration is applied for some or all purposes. In another example, multiple different types of LP-WUS can be configured to serve different purposes. In these examples, a first type of LP-WUS is transmitted periodically for measurement purposes, and a second type of LP-WUS is transmitted aperiodically or on demand to wake up the UE 402 to receive paging and/or to prepare for data reception. At least for RRC idle state UE 402, to receive first and second type LP-WUS, the UE 402 does not need to turn on the MR 105, and the UE 402 turns on the MR 105 only if UE 402 detects a certain type of LP-WUS indicating the UE 402 to turn on the MR 105 (e.g., the second type LP-WUS that indicates paging reception for the UE 402 as mentioned previously).

1.1. RRM Measurement Based on LP-WUS Radio Resource Management (RRM) refers to the system level management of co-channel interference, radio resources, and other radio transmission characteristics in a wireless communication system/network. RRM ensures the efficient use of the available radio resources and also provides mechanisms that enable NR to meet radio resource related requirements. RRM involves strategies and algorithms for controlling parameters such as, for example, transmit power, user allocation, beamforming, data rates, handover criteria, cell selection, modulation scheme, error coding scheme, and/or other parameters such as those discussed herein.

RRM measurement(s) can include measurement(s) for a serving cell, one or more neighbor cells, or both serving cell and one or more neighbor cells. Additionally or alternatively, the RRM measurement(s) can be or include intra-frequency measurement(s), inter-frequency measurement(s), or both intra-frequency and inter-frequency measurement(s).

In various implementations, a UE 402 can at least perform some of RRM measurement(s) based on an LP-WUS (e.g., either of LP-WUS 101a or LP-WUS 101b) when certain criterion/criteria is met, otherwise, the UE 402 performs RRM measurement(s) based on NR synchronization signal blocks (SSB) and/or channel state information reference signals (CSI-RS). The NR SSB can be a non-cell defining (NCD)-SSB or a cell defining (CD)-SSB.

In various implementations, the LR 110 performs and/or collects RRM measurement(s) based on an LP-WUS 101 for RRM measurement (referred to herein as “RRM-LP-WUS”), and the MR 105 performs and/or collects RRM measurement(s) based on NR SSB and/or CSI-RS for RRM measurement (collectively referred to herein as “RRM reference signal” or “RRM-RS”).

In some implementations, the RRM-LP-WUS and the RRM-RS is/are different signals. For example, the RRM-LP-WUS received/measured by the LR 110 can be based on on-off-keying (OOK) and/or frequency shift keying (FSK) symbols, or based on time domain sequence(s), such as Zadoff-chu sequence(s), whereas the RRM-RS received/measured by the MR 105 is an NR SSB and/or a CSI-RS as specified by [TS38211], [TS38212], [TS38213], [TS38214], and/or any other suitable 3GPP standards/specifications.

In some implementations, the RRM-LP-WUS and the RRM-RS can be the same signal, or can be a subset of such signaling. For example, a first subset of RRM-RS (e.g., NR SSB) transmitted by a NAN 414 (or a cell) can be RRM-LP-WUS received/measured by the LR 110 and a second subset of the RRM-RS (e.g., NR SSB and/or CSI-RS) transmitted by the same or different NAN 414 (or same or different cell) can be used for RRM measurement by the MR 105. In this example, the first subset and the second subset can be at least partially overlapped or non-overlapped.

The RRM-LP-WUS can be one of many LP-WUS types. In one example, a first type of LP-WUS and/or a second type of LP-WUS can be used for RRM measurement of a serving cell (e.g., camped cell in idle state), while only the first type of LP-WUS is configured for RRM measurement for neighbor cell(s).

In some implementations, whether RRM can be measured based on LP-WUS can depend on the UE RRC state. The RRC states include RRC_IDLE, RRC_INACTIVE, and RRC_CONNECTED (see e.g., [TS38331]). For example, RRM-LP-WUS measurement can be performed by the LR 110 while in RRC_IDLE and/or RRC_INACTIVE, and RRM-RS measurement can be performed by the MR 105 in RRC_CONNECTED. In another example, RRM-LP-WUS measurement can be performed by the LR 110 in RRC_IDLE, RRC_INACTIVE, and/or RRC_CONNECTED.

In various implementations, a UE 402 can at least perform some RRM measurements based on LP-WUS when certain criterion/criteria is/are met. In addition to RRM-LP-WUS measurement, the UE 402 (MR 105) can perform relaxed RRM measurement.

In some examples, the criterion/criteria can be the UE 402 being configured with/for RRM-LP-WUS. Additional or alternative criterion/criteria can include any of the following scenarios or conditions, individually or in any combination: the UE 402 being in a low mobility condition/scenario; the UE 402 being in a not-at-cell-edge condition/scenario; the UE 402 being in a good serving cell quality condition/scenario; and the UE 402 not being in a DRX on duration. Additional or alternative criterion/criteria can be or include the measurement reporting events discussed in [TS38331] and/or the aforementioned conditions/criteria can be determined based on the measurement reporting events discussed in [TS38331].

For the low mobility scenario, the criterion can be whether a measurement/metric variation is below a threshold and/or a beam variation happening or being below a threshold. For the not-at-cell-edge scenario, the criterion can be whether the measurement/metric is larger than a threshold. Additionally or alternatively, the criterion can be whether a measurement/metric for serving cell is larger than best neighbor cell plus (+) an offset (and/or scaling factor and/or the like). Additionally or alternatively, the criterion/criteria can be whether a detection rate and/or error rate of signal(s) for RRM measurement is lower than a predefined and/or configured threshold. The signal can be the RRM-LP-WUS and/or RRM-RS (e.g., NR SSB and/or CSI-RS).

In any of the examples discussed herein, the detection rate and/or error rate for the RRM-LP-WUS and/or for the RRM-RS can include block error rate (BLER), bit error rate, bit error ratio (BER), packet error rate (PER), packet loss rate (PLR), and/or any other suitable error rate measurement/metric, such as any of those mentioned herein and/or in any suitable 3GPP standard(s)/specification(s). In any of the examples discussed herein, the measurements/metrics performed, measured, or collected for the RRM-LP-WUS and/or the RRM-RS can be, for example, RSRP, RSRQ, SNR, SINR, and/or any other measurement/metric for channel conditions/quality and/or interference conditions/quality, including any of those mentioned herein and/or in any suitable 3GPP standard(s)/specification(s).

In some examples, a UE 402 (MR 105) can be configured with potential relaxed RRM measurement, but not configured with RRM-LP-WUS for measurement. The criterion/criteria for the relaxed RRM measurement without aid of LP-WUS and the relaxed RRM measurement with aid of LP-WUS can be different. Even for the same criterion, the threshold to evaluate the criterion can be separately configured for these two cases. For example, the metric/measurement (e.g., RSRP, RSRQ, SNR, SINR, and/or the like) threshold for not-at-cell-edge scenario for RRM-LP-WUS measurement can be lower than the metric/measurement (e.g., e.g., RSRP, RSRQ, SNR, SINR, and/or the like) threshold for the not-at-cell-edge scenario for RRM measurement at the MR 105.

The UE 402 can evaluate whether the UE 402 is in or out of a certain scenario based on the measurement(s) performed/collected by the MR 105. In some examples, there can be two cases.

For the first case, the UE 402 has not offloaded RRM measurement to LP-WUS (or the LR 110) yet. The UE 402 can first validate whether certain criterion/criteria for offloading is met by the MR 105. For example, if the UE 402 (MR 105) has performed/collected normal measurement(s) for at least a period T₁ and the criterion for the low mobility scenario is fulfilled for the period T₁ (see e.g., FIG. 2), the UE 402 can use the LP-WUS for at least some RRM measurements; otherwise, the UE 402 (MR 105) continues to use the RRM-RS for RRM measurement, and the UE 402 can continue the validation of criterion for the low mobility scenario. For the second case, after the criterion/criteria has been met, the UE 402 can use the LP-WUS for at least some RRM measurement(s). Meanwhile, the UE 402 can continue validation of the criterion/criteria. If the criterion/criteria is/are still met, the UE 402 (LR 110) can continue RRM measurement based on the RRM-LP-WUS; otherwise, the UE 402 (MR 105) falls back to use RRM-RS for RRM measurement.

FIG. 2 depicts two example timings 200a and 200b for criteria evaluation by the MR 105.

In these examples, the UE 402 (MR 105) evaluates (or performs measurement(s)) for (or during) a first time period (T₁) to determine whether the LP-WUS can be used for measurement within an interval that is no more than a second time period (T₂). For example, the UE 402 can evaluate multiple slots in T₁ and the UE 402 determines whether the criterion/criteria for the low mobility scenario is fulfilled for the period of T₁, and the UE 402 can perform RRM-LP-WUS measurement in a period up to T₂ without checking the validity of the low mobility scenario by the MR 105.

Then, the UE 402 (MR 105) re-evaluates the low mobility scenario again in a next period of T₁.

In some implementations, the UE 402 only turns on the MR 105 to perform RRM measurement together with the monitoring paging information during period T₁. Additionally or alternatively, it is up to UE implementation when the UE 402 turns on the MR 105 to perform RRM measurement. Additionally or alternatively, the UE 402 (MR 105) evaluates for (during) multiple T₁ periods to determine whether the LP-WUS can be used for measurement. For example, the UE 402 can check an average measurement (e.g., RSRP, RSRQ, SNR, SINR, and/or the like) within first and second T₁ periods, and then check average measurements (e.g., RSRP, RSRQ, SNR, SINR, and/or the like) within second and/or third T₁ periods.

The UE 402 can also evaluate whether the UE 402 is in or out of certain scenario based on the measurement(s) performed/collected by the LR 110. In these implementations, the UE 402 (LR 110) can evaluate for (during) a third time period (T₃) within an interval no less than a fourth time period (T₄). If the criterion/criteria is met, the UE 402 (LR 110) can continue using the RRM-LP-WUS for at least some of RRM measurements, otherwise, the UE 402 (MR 105) falls back to use the RRM-RS for RRM measurement. The period T₃ may be the same or different than T₁ and/or T₂, and/or T₄ may be the same or different than T₁ and/or T₂.

In some implementations, if the UE 402 (LR 110) identifies or determines that a measurement result (e.g., RSRP, RSRQ, SNR, SINR, and/or the like) is lower than a threshold for a fifth time period (T₅), the UE 402 (MR 105) falls back to use RRM-RS for RRM measurement; otherwise, the UE 402 (LR 110) can continue using the LP-WUS for at least some of RRM measurements. Additionally or alternatively, if the UE 402 (LR 110) identifies or determines that a number of measurement results (e.g., RSRP, RSRQ, SNR, SINR, and/or the like) is/are lower than the same or different threshold, the UE 402 (MR 105) falls back to use RRM-RS for RRM measurement; otherwise, the UE 402 (LR 110) can continue using the LP-WUS for at least some of RRM measurements. Additionally or alternatively, if the UE 402 (LR 110) identifies or determines that an average of such measurement results is/are lower than the same or different threshold, the UE 402 (MR 105) falls back to use RRM-RS for RRM measurement; otherwise, the UE 402 (LR 110) can continue using the LP-WUS for at least some of RRM measurements.

Additionally or alternatively, if the UE 402 (LR 110) identifies or determines that a number of measurement results (e.g., RSRP, RSRQ, SNR, SINR, and/or the like) is larger than a configured or pre-defined number within a period T₅, the UE 402 (MR 105) falls back to use RRM-RS for RRM measurement; otherwise, the UE 402 (LR 110) can continue using the LP-WUS for at least some of RRM measurements. Additionally or alternatively, if the UE 402 (LR 110) identifies or determines that consecutive L measurement results (e.g., RSRP, RSRQ, SNR, SINR, and/or the like) is/are lower than a same or different threshold, the UE 402 (MR 105) falls back to use RRM-RS for RRM measurement; otherwise, the UE 402 (LR 110) can continue using the LP-WUS for at least some of RRM measurements.

Additionally or alternatively, if the UE 402 (LR 110) identifies or determines that a detection rate and/or error rate (e.g., BLER, bit error rate, BER, PER, PLR, and/or the like) of the RRM-LP-WUS is lower than a predefined or configured threshold within a sixth time period (T₆), the UE 402 (MR 105) falls back to use RRM-RS for RRM measurement; otherwise, the UE 402 (LR 110) can continue using LP-WUS for at least some of RRM measurements. The detection rate and/or error rate (e.g., BLER, bit error rate, BER, PER, PLR, and/or the like) can be obtained by the number of actually detected RRM-LP-WUS and/or can be derived based on the measurement result. For example, the UE 402 can derive a detection rate and/or error rate (e.g., BLER, bit error rate, BER, PER, PLR, and/or the like) according to SNR, SINR, and/or some other suitable measurement(s) and/or hypothetical RRM-LP-WUS transmission parameters. In these examples, the LR 110 in the UE 402 can monitor the first type of RRM-LP-WUS in every period, and the UE 402 checks whether the number of actually detected RRM-LP-WUS is lower than a predefined or configured threshold and/or whether N_{RRM-LP-WUS}_{_{detected}}/N_{RRM-LP-WUS}_{ₜₒₜₐₗ} is lower than the same or different predefined or configured threshold, wherein N_{RRM}-LP-WUS_{detected} is the number of actually detected RRM-LP-WUS, and N_{RRM-LP-WUS}_{ₜₒₜₐₗ} is a total number of RRM-LP-WUS.

The number of actually detected RRM-LP-WUS can be the number of consecutive detections of RRM-LP-WUSs within the period T₆. Additionally or alternatively, the number of actually detected RRM-LP-WUS can be consecutive or non-consecutive RRM-LP-WUSs within period T₆. In any of the examples discussed herein, the time period T₆ may be have a same, similar, or different value than any of the other time periods discussed herein.

If the RRM-LP-WUS is based on sequence, the UE 402 can determine whether the RRM-LP-WUS is actually detected by comparing the sequence correlation result and a threshold. If the RRM-LP-WUS has a Cyclic Redundancy Check (CRC), the UE 402 can determine whether the RRM-LP-WUS is detected by checking CRC. If an RRM-LP-WUS includes at least two parts and at least one part is based on sequence and one part has a CRC, the detection of the RRM-LP-WUS can be based on detection of sequence and/or CRC checking. Additionally or alternatively, the LR 110 and/or UE 402 can monitor the first type of RRM-LP-WUS in every period, and the UE 402 checks whether the derived detection rate and/or error rate (e.g., BLER, bit error rate, BER, PER, PLR, and/or the like) is lower than a predefined or configured threshold. The detection rate and/or error rate (e.g., BLER, bit error rate, BER, PER, PLR, and/or the like) can be derived based on one or more measurements/metrics (e.g., RSRP, RSRQ, SNR, SINR, and/or the like) and/or hypothetical RRM-LP-WUS transmission parameters, which is similar to the RLM metrics Qᵢₙ or Qₒᵤₜ derived based on the hypothetical PDCCH transmission parameter(s).

FIG. 3 depicts an example evaluation 300 by the LR 110 within a period T₆ with sliding window step of an LP-WUS period (or RRM-LP-WUS period). In this example, M is a number of LP-WUS occasions within a period T₆, and the step for sliding the period is N*T_{LP-WUS} where T_{LP-WUs} is the LP-WUS period and N=1 in this example. The UE 402 checks whether the detection rate of LP-WUS in each period T₆ is lower than a predefined or configured threshold. As an example, the detection rate can be derived as follows:

$${R}_{d e t e c t} = \frac{{N}_{LP - {WUS}_{detected}}}{M}$$

where R_{detect} is the detection rate, N_{LP-WUS}_{_{detect}}ed is the number of detected LP-WUS, and M is discussed previously. In some examples, the N_{LP-WUS}_{_{detected}} can be the same or similar as the N_{RRM-LP-WUS}_{_{detected}} discussed previously. In these examples, if the detection rate is lower than the predefined or configured threshold, the UE 402 falls back to use RRM-RS (e.g., NR SSB and/or CSI-RS) for RRM measurement by the MR 105.

In some implementations, the UE 402 can evaluate whether the UE 402 is in or out of certain scenario using both the LR 110 and the MR 105. If at least one result by the MR 105 or the LR 110 does not meet the criterion/criteria, the UE 402 falls back to use RRM-RS for RRM measurement by the MR 105.

In some implementations, if X results by the MR 105 and/or by the LR 110 does not meet the criterion/criteria, the UE 402 (MR 105) falls back to use the RRM-RS for RRM measurement.

In these implementations, X is a value (e.g., a number of measurement results that meet the criterion/criteria) that can be predefined or configured by high layer signaling. Additionally or alternatively, if X₁ results by the MR 105 and/or X₂ results by the LR 110 does/do not meet the criterion/criteria, the UE 402 falls back to use the RRM-RS for RRM measurements by the MR 105. In these implementations, X₁ and X₂ are values (e.g., respective numbers of measurement results that meet the criterion/criteria) that can be predefined or configured by high layer signaling. In some examples, X₁<X₂. In other examples, X₁≤X₂ or X₁≤X₂.

In some implementations, the UE 402 can report the change to a RAN node 414 via the MR 105 (e.g., the UE 402 can initiate the UE assistance information procedure upon change of its status of certain scenario(s), or use some other RRC procedures/techniques to report the change(s)). For example, the UE 402 can enter RRC_CONNECTED to report the change or detected measurements. In another example, when UE 402 enters RRC_CONNECTED, the UE 402 can report the current scenario or report the change of scenario. Additionally or alternatively, the UE 402 can perform corresponding measurement(s) when the criterion/criteria of certain scenario(s) is met, with or without reporting such changes to the RAN node 414. For example, for a UE 402 in RRC_IDLE, the UE 402 may perform RRM measurement based on RRM-LP-WUS and relaxed RRM measurement by the MR 105 if the criterion/criteria is met, without switching to RRC_CONNECTED to report to the RAN node 414.

In various implementations, when the certain criterion/criteria is met, the UE 402 can perform some of RRM measurement based on RRM-LP-WUS and/or the UE 402 can perform relaxed RRM measurement based on RRM-RS by the MR 105. The relaxation of RRM measurements based on RRM-RS by the MR 105 includes a relaxed measurement period and/or a relaxed number of measurements to be averaged in a measurement period.

For relaxation of RRM measurement requirement for the MR 105, in some implementations, the relaxation for serving cell and/or neighbor cell(s) by the MR 105 is the same. For example, assuming normal measurement period for serving cell and neighbor cell is Tₛ and Tₙ, respectively, the relaxation of the measurement period for serving cell and neighbor cell is Mrexₛ*Tₛ and Mrexₙ*Tₙ, respectively (where Mrexₛ is a relaxation (or scaling factor) for the serving cell measurement period, and Mrexₙ is a relaxation (or scaling factor) for a neighbor cell measurement period). Additionally or alternatively, the relaxation for the serving cell and neighbor cell by the MR 105 is separately determined (e.g., the relaxation of measurement period for serving cell and neighbor cell is Mrexₛ*Tₛ and Mrexₙ*Tₙ respectively). Additionally or alternatively, the relaxation for intra-frequency and inter-frequency measurement by the MR 105 is the same. Additionally or alternatively, the relaxation for intra-frequency and inter-frequency measurement by the MR 105 is separately determined. Additionally or alternatively, the relaxation for measurement by the MR 105 is the same for any RRC state. Additionally or alternatively, the relaxation for measurement by the MR 105 for different RRC states can be separately configured and/or determined, for example, the relaxation for RRC_IDLE and RRC_CONNECTED can be separately configured. In any of the aforementioned examples, the relaxation scale (e.g., Mrex, Mrexₛ, or Mrexₙ) can depend on the periodicity of the RRM-RS for RRM measurement.

For criterion/criteria relaxation of RRM measurement requirements for the MR 105, in some examples, same relaxed criterion/criteria is configured for both serving cell and neighbor cell measurement by the MR 105. For example, if the UE 402 is configured with RRM-LP-WUS and lowMobilityEvalutation criterion, a single measurement (e.g., RSRP, RSRQ, SNR, SINR, and/or the like) variation threshold SSearchDeltaP for low mobility evaluation is configured for both the serving cell and the neighbor cell. Additionally or alternatively, relaxed relaxed criterion/criteria for the serving cell and the neighbor cell measurement by the MR 105 are configured separately or respectively (e.g., where the measurement variation threshold for the RRM-RS is different than a measurement variation threshold used from RRM-LP-WUS).

Additionally or alternatively, same relaxed relaxed criterion/criteria is configured for both intra-frequency and inter-frequency measurement by the MR 105. Additionally or alternatively, relaxed relaxed criterion/criteria is configured for intra-frequency and inter-frequency measurement by the MR 105 separately or respectively. Additionally or alternatively, a same relaxed criterion/criteria is configured for any RRC state. Additionally or alternatively, the criterion/criteria for different RRC states can be separately configured, for example, the criterion/criteria for RRC_IDLE and RRC_CONNECTED can be separately configured. Additionally or alternatively, the measurement period can be dependent on whether the lowMobilityEvalutation criterion is set.

In some implementations, when the certain criterion/criteria is met, the UE 402 can perform some or all RRM measurement(s) based on the RRM-LP-WUS without the need of turning on the MR 105 to perform RRM measurement. If the MR 105 has been turned on for other purposes (e.g., when the UE 402 is in RRC_CONNECTED, or when the UE 402 receives paging information or system information before RRC connection), RRM measurement can be performed by the MR 105.

The criterion/criteria discussed previously can be applied to check whether the UE 402 can perform some or all RRM measurement(s) based on the RRM-LP-WUS without the need to turn on the MR 105 to perform RRM measurement.

Additionally or alternatively, the same or different criterion/criteria can be applied to check whether the UE 402 can perform some or all RRM measurement(s) based on the RRM-LP-WUS and perform relaxed RRM measurement(s) by the MR 105 and/or the UE 402 can perform some or all RRM measurement(s) based on the RRM-LP-WUS without the need to turn on the MR 105 to perform RRM measurement(s). Fore example, the same or different thresholds can be predefined or configured for these two cases.

Additionally or alternatively, when the certain criterion/criteria is met, the UE 402 (LR 110) can perform at least some of the RRM measurement(s) based on the RRM-LP-WUS and the UE 402 (MR 105) can perform relaxed RRM measurement based on the RRM-RS. The RRM measurement requirement based on LP-WUS can depend on the criterion/criteria. The value of measurement period and/or the number of measurements for average in a period may be separately determined according to different thresholds. For example, for a UE 402 in the not-at-cell-edge scenario, the UE 402 can be configured with two thresholds including: SSearchThresholdP1 and SSearchThresholdP2. If SSearchThresholdP2≥Srxlev>SSearchThresholdP1, the measurement period by LP-WUS is TL1, and if Srxlev>SSearchThresholdP2, the measurement period by LP-WUS is TL2, and TL2>TL1. In this example, the parameter Srxlev is a cell selection Rx level (see e.g., 3GPP TS 38.304 § 5.2.3.2).

For RRM measurement requirement for the LR 110, in some implementations, the measurement requirement for serving cell and neighbor cell by LR 110 is the same. Additionally or alternatively, the measurement requirement for serving cell and neighbor cell to be measured by the LR 110 are different and/or are separately determined. Additionally or alternatively, the measurement requirement for intra-frequency and inter-frequency measurement by the LR 110 is the same. Additionally or alternatively, the measurement requirement for intra-frequency and inter-frequency measurement by the LR 110 are different and/or are separately determined.

Additionally or alternatively, same measurement requirements is/are configured for measurement by the LR 110 for any RRC state. Additionally or alternatively, the measurement requirements for measurements by the LR 110 are different for different RRC states and/or can be separately configured. For any of the aforementioned examples, the minimum measurement requirement can depend on the periodicity of the LP-WUS.

In various implementations, when the certain criterion/criteria is met, the UE 402 (LR-WUR 110) can perform at least some of RRM measurements based on the LP-WUS, and the UE 402 (MR 105) can perform relaxed RRM measurements based on RRM-RS. In some implementations, the UE 402 (MR 105) can perform RRM measurement with a period Tₘ, and the UE 402 (LR 110) can perform RRM measurement ML times within a period Tₘ (e.g., where M and L are discussed previously). In some examples, the UE 402 can combine the RRM measurement results performed/collected by the MR 105 and the LR 110 within the period Tₘ and evaluate the combined measurement results. For example, the UE 402 can determine whether the combined measurement results is/are below or above a Srxlev threshold within a period (e.g., period Tₘ or a different time period).

Additionally or alternatively, the UE 402 (MR 105) can perform RRM measurement with a period Tₘ, and the UE 402 (LR 110) can perform RRM measurement with a period period T_{L}.

In some examples, the UE 402 can evaluate the measurement results by the MR 105 and the LR 110, respectively, for example, whether the measurement result by the MR 105 is below or above a Srxlev threshold within a period Tₘ and whether the measurement result by the LP-WUS is below or above a Srxlev threshold within a period T_{L}, where the threshold can be single value or separately configured for the MR 105 and the LR 110.

To combine the measurement result of the LR 110 and the MR 105, in some implementations, the transmission power of the RRM-LP-WUS and RRM-RS for RRM measurement can be provided by the RAN node 414 (e.g., in a suitable RRC message, downlink control information (DCI) message, medium access control (MAC) control element (CE), and/or the like). Additionally or alternatively, the power ratio of the RRM-LP-WUS and RRM-RS for RRM measurement can be provided by the RAN node 414, and the UE 402 can combine the measurement results performed/collected by the LR 110 and the MR 105 based on the provided ratio.

1.2. Radio Link Monitoring/Beam Failure Detection Based on LP-WUS In various implementations, when a UE 402 is in RRC_CONNECTED, the UE 402 can perform at least some RLM measurement(s) and/or BFD based on the LP-WUS 101 (referred to herein as “RLM-LP-WUS”, “BFD-LP-WUS”, and/or “RLM/BFD-LP-WUS”) when certain criterion/criteria is met, otherwise, the UE 402 always performs RLM/BFD based on NR SSB or CSI-RS (collectively referred to herein as “RLM-RS”, “BFD-RS”, and/or “RLM/BFD-RS”). In some implementations, the LP-WUS (or RLM/BFD-LP-WUS) can be one of LP-WUS types, for example, a first type LP-WUS, or multiple of LP-WUS types, and/or both the first type LP-WUS or second type LP-WUS.

In various implementations, the UE 402 (LR 110) can perform at least some RLM/BFD-LP-WUS measurements when certain criterion/criteria is met and/or the UE 402 (MR 105) can perform relaxed RLM/BFD-RS measurement. In some examples, the certain criterion/criteria includes the UE 402 being configured with or for LP-WUS for RLM/BFD measurement.

Additional or alternative criterion/criteria can include any of the following conditions/scenarios, individually or in any combination: the UE 402 being in a low mobility condition/scenario; the UE 402 being in a not-at-cell-edge condition/scenario; the UE 402 being in a good serving cell quality condition/scenario; and/or the UE 402 not being in a DRX on duration. Additional or alternative criterion/criteria can be or include the measurement reporting events discussed in [TS38331] and/or the aforementioned conditions/criteria can be determined based on the measurement reporting events discussed in [TS38331].

For low mobility scenario, the criterion/criteria can be whether a measurement/metric (e.g., RSRP, RSRQ, SNR, SINR, and/or some other measurement(s)/metric(s) for channel conditions/quality and/or interference conditions/quality, such as any of those mentioned herein and/or in any suitable 3GPP standards/specifications) variation is below a predefined or configured threshold, or beam variation happens. For not-at-cell-edge/good serving cell quality scenario, the criterion/criteria can be whether the downlink radio link quality on the configured RLM-RS resource or BFD-RS resource is larger than a threshold. The RLM-RS/BFD-RS can be SSB or CSI-RS or LP-WUS.

The UE 402 can evaluate whether the UE 402 is in or out of certain scenario based on the measurement(s) collected/performed by the MR 105 and/or the measurement(s) collected/performed by the LR 110. For example, the UE 402 can combine the measurement result(s) by collected/performed by the MR 105 and the LR 110 to check against Qₒᵤₜ and Qᵢₙ.

Additionally, the UE 402 can report the change(s) to the RAN node 414 via the MR 105. For example, the UE 402 can wake up the MR 105 and initiate the UE assistance information procedure upon detecting change(s) of its status of certain scenarios/conditions/events. If the criterion/criteria for scenario/condition that a UE 402 can use LR 110 for RLM/BFD measurement is not met, the UE 402 (MR 105) can fall back to the RLM/BFD measurement and/or the UE 402 (MR 105) can initiate radio link recovery and/or beam failure recovery procedures according to legacy procedures/techniques. For example, if the UE 402 was in a scenario to perform some or all RLM/BFD-LP-WUS measurements without the need to switch the MR 105 from the sleep/inactive state to the ON/active state/mode to perform BFD or RLM, and if the UE 402 identifies beam failure or radio link failure (RLF) by LP-WUS, the UE 402 can wake up the MR 105 to perform BFD or RLM again and/or the UE 402 (MR 105) can directly initiate the BFR/RLF procedures accordingly.

In various implementations, when the certain criterion/criteria is/are met, the UE 402 (LR 110) can perform at least some RLM/BFD measurements based on RLM/BFD-LP-WUS and the UE 402 (MR 105) can perform relaxed RLM/BFD measurement based on the RLM/BFD-RS.

Additionally or alternatively, the UE 402 (LR 110) can perform some or all RLM/BFD measurements based on the LP-WUS without the need of switching the MR 105 from the sleep/inactive state to the ON/active state/mode to perform RLM/BFD. If the MR 105 has been in the on/active mode for other purposes (e.g., when the UE 402 is in an on duration (e.g., DRX/eDRX on duration), the UE 402 is monitoring the PDCCH, the UE 402 is to received PDSCH, and/or the like), RLM/BFD can be performed by the MR 105.

The relaxation of RLM/BFD measurement (RLM/BFD-RS measurement) by the MR 105 include at least one of a relaxed indication period for radio link quality assessment for RLM/BFD by layer 1 (L1), relaxed evaluation period, and/or a relaxed number of measurements for averaging in an evaluation period.

The minimum requirement of RLM/BFD measurements based on RLM/BFD-LP-WUS by the LR 110 can be based on a LP-WUS periodicity and/or DRX/eDRX cycle. Additionally or alternatively, the minimum requirement of RLM/BFD measurements based on RLM/BFD-LP-WUS by the LR 110 can be based on the radio link conditions/quality (e.g., RSRP, RSRQ, SNR, SINR, and/or the like) measured by the MR 105.

The criterion/criteria and relaxation of RLM/BFD measurement based on RLM/BFD-RS by the MR 105 can be separately configured. Additionally or alternatively, a single criterion/criteria and relaxation of RLM/BFD measurement based on RLM/BFD-RS by the MR 105 can be configured. In some examples, a similar mechanism discussed above can be applied to CSI measurement, such as CSI-RS, L1-RSRP, and/or the like.

### 1.3. Activation/Deactivation of LP-WUS Monitoring

In various implementations, a UE 402 with LP-WUS monitoring capability can activate/deactivate LP-WUS monitoring based on network (e.g., RAN 404 or RAN node 414) configuration. For example, if a RAN node 414 indicates LP-WUS in a system information block (SIB), the UE 402 can activate LP-WUS monitoring when the UE 402 enters RRC_IDLE or RRC_INACTIVE. In another example, if the RAN node 414 indicates LP-WUS monitoring in an RRC release message for the UE 402, the UE 402 can activate LP-WUS monitoring when the UE 402 enters RRC_IDLE or RRC_INACTIVE.

In various implementations, a UE 402 with LP-WUS monitoring capability can activate/deactivate LP-WUS monitoring based on configuration and/or based on certain criterion/criteria. In some implementations, when LP-WUS monitoring is configured by a RAN node 414, the UE 402 can determine whether to activate or deactivate LP-WUS monitoring based on certain criterion/criteria; otherwise, if LP-WUS monitoring is not configured by the RAN node 414, the UE 402 does not perform LP-WUS monitoring. For example, in addition to RAN node configuration, if serving cell measurement(s) (e.g., RSRP, RSRQ, SNR, SINR, and/or the like) collected/performed/measured by the MR 105 for a predefined or configured period is larger than a predefined or configured threshold, the UE 402 can active LP-WUS monitoring when the UE 402 enters RRC idle/inactive state.

Referring to FIG. 2 as an example, if the serving cell measurement (e.g., RSRP, RSRQ, SNR, SINR, and/or the like) by the MR 105 for a period T₁ is larger than a predefined or configured threshold for LP-WUS activation, the UE 402 can active LP-WUS monitoring. In this example, the UE 402 can monitor LP-WUS at least in several T₂ periods until the serving cell measurement(s) (e.g., RSRP, RSRQ, SNR, SINR, and/or the like) performed/collected/measured by the MR 105 for a period T₁ is lower than a predefined or configured threshold (e.g., in the third T₁ period in FIG. 2). Then, the UE 402 deactivates LP-WUS monitoring after the third T₁ period.

Referring to FIG. 3 as another example, if the detection rate of the LP-WUS by the LR 110 is lower than a predefined or configured threshold for a period T₆, the UE 402 deactivates LP-WUS monitoring and falls back to the MR 105.

In some implementations, the UE 402 can report whether the certain criterion/criteria is met for LP-WUS monitoring. In these implementations, if the criterion/criteria is/are met, the UE 402 can request to use LP-WUS monitoring, when the UE 402 is in RRC_CONNECTED.

Additionally or alternatively, the UE 402 can request to use LP-WUS monitoring, and if the UE 402 identifies or determines that the certain criterion/criteria is/are met for LP-WUS monitoring, the UE 402 can activate LP-WUS monitoring. In any of the examples discussed herein, the LP-WUS monitoring can be requested by, for example, transmitting a suitable request message/signal to the RAN node 414 or some other network entity/element.

For any of the examples discussed herein, in some implementations, single criterion/criteria applies for both activation and deactivation of LP-WUS monitoring and LP-WUS measurement in previous implementations. For example, if LP-WUS monitoring is activated, the UE 402 can perform/collect measurement(s) based on LP-WUS and identify potential paging by LP-WUS. If LP-WUS is deactivated, the UE 402 only uses the MR 105 for both potential paging and performing RS, RRM, RLM, and/or BFD measurements.

Additionally or alternatively, the criterion/criteria for activation/deactivation of LP-WUS monitoring and the criterion/criteria for LP-WUS measurement in any of the previous implementations are different and/or can be separately configured. For example, the measurement threshold (e.g., RSRP, RSRQ, SNR, SINR, and/or the like) or detection rate threshold (e.g., BLER, bit error rate, BER, PER, PLR, and/or the like) for activation/deactivation of LP-WUS monitoring and LP-WUS measurement can be separately configured. If the criterion/criteria for LP-WUS monitoring is met, while the criterion/criteria for RRM/RLM/BFD-LP-WUS measurement is not met, the UE 402 still relies on the MR 105 for RRM/RLM/BFD measurement (e.g., measuring RRM/RLM/BFD-RS), but the UE 402 can rely on LP-WUS to identify potential paging.

For any of the examples discussed herein, in some implementations, whether single or separate criterion/criteria for activation/deactivation of LP-WUS monitoring and LP-WUS measurement is based on the periodicity of a DRX/eDRX cycle. For example, if the DRX/eDRX cycle is no larger than 1.28 seconds, the single criterion/criteria for activation/deactivation of LP-WUS monitoring and LP-WUS measurement is applied.

For any of the examples discussed herein, the criterion/criteria for activation/deactivation of LP-WUS monitoring and/or criterion/criteria for LP-WUS measurement can depend on the periodicity of DRX/eDRX cycle, or separately configured for different periodicity of DRX/eDRX cycle. For example, two thresholds or two criterion/criteria can be separately provided/configured for a first UE 402 (UE1) configured with DRX with periodicity smaller than P1 and a second UE 402 (UE2) configured with eDRX with periodicity no smaller than P1. The threshold can be provided in cell-specific signaling, such as SIB or UE-specific signaling.

### 2. Cellular Network Aspects

FIG. 4 depicts an example network architecture 400. The network 400 may operate in a manner consistent with 3GPP technical specifications for LTE or 5G/NR systems. However, the example implementations are not limited in this regard and the described examples may apply to other networks that benefit from the principles described herein, such as future 3GPP systems, or the like.

The network 400 includes a UE 402, which is any mobile or non-mobile computing device designed to communicate with a RAN 404 via an over-the-air (OTA) connection. The UE 402 is communicatively coupled with the RAN 404 by a Uu interface. Examples of the UE 402 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, Internet of Things (IoT) device, smart appliance, unmanned aerial vehicle (UAV), drone, robot (semi-)autonomous vehicle, electronic signage, single-board computer, plug computers, and/or any other type of computing device, such as any of those discussed herein.

In some examples, the network 400 includes a set of UEs 402 coupled directly with one another via a sidelink (SL) interface, which involves communication between two or more UEs 402 using 3GPP technology without traversing a network node. Here, the SL interface includes, for example, one or more SL logical channels (e.g., sidelink broadcast control channel (SBCCH), sidelink control channel (SCCH), and sidelink traffic channel (STCH)); one or more SL transport channels (e.g., sidelink shared channel (SL-SCH) and sidelink broadcast channel (SL-BCH)); and one or more SL physical channels (e.g., physical sidelink shared channel (PSSCH), physical sidelink control channel (PSCCH), physical sidelink Feedback channel (PSFCH), physical sidelink broadcast channel (PSBCH), and/or the like). The UE 402 may perform blind decoding attempts of SL channels/links according to the various examples herein.

In some examples, the UE 402 can communicate with an access point (AP) 406 via an OTA connection. The AP 406 manages a WLAN connection between the UE 402 and the AP 406, which is consistent with any IEEE 802 protocol. Additionally, the UE 402, RAN 404, and AP 406 may utilize cellular-WLAN aggregation/integration (e.g., LWA/LWIP), which may serve to offload some/all network traffic from the RAN 404.

The RAN 404 includes one or more network access nodes (NANs) 414 (also referred to as “access network nodes” and/or the like). The NANs 414 terminate air-interface(s) for the UE 402 by providing access stratum protocols including RRC, PDCP, RLC, MAC, and PHY/L1 protocols. In this manner, the NANs 414 enable data/voice connectivity between the CN 440 and the UE 402. The NANs 414 may be a macrocell base station or a low power base station for providing femtocells, picocells or other like cells having smaller coverage areas, smaller user capacity, or higher bandwidth compared to macrocells; or some combination thereof. In these implementations, an NAN 414 be referred to as a BS, gNB, RAN node, eNB, ng-eNB, NodeB, RSU, TRP, and the like. The RAN 404 may have an NG-RAN architecture as discussed in 3GPP TS 38.401.

The RAN 404 (or individual NANs 414) may provide the air interface over a licensed spectrum or an unlicensed spectrum. To operate in the unlicensed spectrum, the nodes may use LAA, eLAA, and/or feLAA mechanisms based on CA technology with PCells/SCells. Prior to accessing the unlicensed spectrum, the nodes may perform medium/carrier-sensing operations based on, for example, a listen-before-talk (LBT) protocol.

The set of NANs 414 are coupled with one another via respective Xn interfaces if the RAN 404. The Xn interfaces, which may be separated into control/user plane interfaces in some examples, allow the NANs 414 to communicate information related to handovers, data/context transfers, mobility, load management, interference coordination, and the like. The NANs 414 manage one or more cells, cell groups, component carriers (CCs), and the like to provide the UE 402 with an air interface for network access. The UE 402 may be simultaneously connected with a set of cells provided by the same or different NANs 414 of the RAN 404 or a different RAN 404.

For example, the UE 402 and RAN 404 may use carrier aggregation (CA) to allow the UE 402 to connect with a set of CCs, each corresponding to a primary cell (PCell) or secondary cell (SCell).

The NG-RAN 404 supports multi-radio DC (MR-DC) operation where a UE 402 is configured to utilize radio resources provided by two distinct schedulers, located in at least two different NG-RAN nodes 414 connected via a non-ideal backhaul, one NG-RAN node 414 providing NR access and the other NG-RAN node 414 providing either E-UTRA or NR access. Further details of MR-DC operation, including conditional PSCell addition (CPA) and conditional PSCell change (CPC), can be found in 3GPP TS 36.300 (“[TS36300]”), [TS38300], and 3GPP TS 37.340.

Individual UEs 402 can be configured to measure or collect radio information, and provide the radio information to one or more NANs 414. The radio information may be in the form of one or more measurement reports, and/or may include, for example, signal strength measurements, signal quality measurements, and/or the like. Each measurement report can be tagged with a timestamp and the location of the measurement (e.g., the UEs 402 current location). For example, the UE 402 can perform reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 402 can include those discussed in 3GPP TS 38.211 (“[TS38211]”), 3GPP TS 38.212 (“[TS38212]”), 3GPP TS 38.213 (“[TS38213]”), 3GPP TS 38.214 (“[TS38214]”), 3GPP TS 36.214 (“[TS36214]”), 3GPP TS 38.215 (“[TS38215]”), 3GPP TS 38.101-1 (“[TS38101-1]”), 3GPP TS 38.104 (“[TS38104]”), 3GPP TS 38.113 (“[TS38113]”), 3GPP TS 38.133 (“[TS38133]”), 3GPP TS 38.331 (“[TS38331]”), and/or other the like standards/specifications. The physical signals and/or reference signals can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), sounding reference signal (SRS), and/or the like. Examples of the measurements performed/collected by individual UEs 402 and/or included in measurement reports can include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/N₀), energy per chip to interference power density ratio (E_{c}/I₀), energy per chip to noise power density ratio (E_{c}/N₀), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR, GNSS code measurements, GNSS carrier phase measurements, Accumulated Delta Range (ADR), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., IEEE 802, IEEE 802.11, IEEE 802.15, IEEE 1609.0, and/or the like) networks.

Other measurements may be additionally or alternatively used, such as those discussed in [TS36214], [TS38215], 3GPP TS 38.314 (“[TS38314]”), 3GPP TS 28.552 (“[TS28552]”), 3GPP TS 32.425 (“[TS32425]”), IEEE 802.11, and/or the like. Additionally or alternatively, any of the aforementioned measurements (or combination of measurements) may be collected by one or more NANs 414 and/or other network nodes.

As alluded to previously, the NG-RAN 414 provides a 5G-NR air interface (e.g., Uu interface), which may have the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

Downlink (DL), uplink (UL), and SL transmissions are organized into frames, and individual frames are organized into a set of subframes. A subframe is a time interval during which one or more signals is/are signaled (e.g., transmitted and/or received). In some implementations, each frame is divided into two equally-sized half-frames of five subframes each. The slot duration is 14 symbols with normal cyclic prefix (CP) and 12 symbols with extended CP, and scales in time as a function of the used sub-carrier spacing so that there is always an integer number of slots in a subframe. A time slot (or “slot”) is an integer multiple of consecutive subframes. A timing advance (TA) is used to adjust the UL frame timing relative to the DL frame timing.

In particular, DL, UL, and SL transmissions are organized into frames with T_{f}=(ΔfₘₐₓN_{f}/100)·T_{c}=10 ms duration, each including ten subframes of T_{sf}=(ΔfₘₐₓN_{f}/1000)·T_{c}=1 ms duration. The number of consecutive OFDM symbols per subframe is

$${N}_{s y m b}^{subframe , μ} = {N}_{s y m b}^{slot} {N}_{slot}^{s u b f r ame , μ} .$$

Each frame is divided into two equally-sized half-frames of five subframes each with half-frame 0 including subframes 0-4 and half-frame 1 including subframes 5-9. There is one set of frames in the UL and one set of frames in the DL on a carrier. UL frame number i for transmission from the UE 402 starts

$${T}_{T A} = ( {N}_{T A} + {N}_{TA , offset} + {N}_{T A , a d j}^{c o m m o n} + {N}_{T A , a d j}^{U E} ) {T}_{c}$$

before the start of the corresponding downlink frame at the UE where N_{TA} and N_{TA,offset} are given by [TS38213]§ 4.2, except for msgA transmission on PUSCH where N_{TA}=0 is used;

$${N}_{TA , adj}^{common}$$

given by [TS38213]§ 4.2 is derived from the higher-layer parameters ta-Common, ta-CommonDrift, and ta-CommonDriftVariant if configured, otherwise

$${N}_{T A , adj}^{common} = 0 ; and {N}_{T A , adj}^{UE}$$

given by [TS38213]§ 4.2 is computed by the UE based on UE position and serving-satellite-ephemeris-related higher-layers parameters if configured, otherwise

$${N}_{T A , a d j}^{U E} = 0 .$$

The DL transmission waveform is conventional OFDM using a cyclic prefix (CP). The UL transmission waveform is conventional OFDM using a CP with a transform precoding function performing DFT spreading that can be disabled or enabled. For operation with shared spectrum channel access in frequency range 1 (FR1), the UL transmission waveform subcarrier mapping can map to subcarriers in one or more PRB interlaces. The numerology is based on exponentially scalable SCS Δf=2^{μ}×15 kHz with μ={0,1,3,4,5,6} for PSS, SSS and PBCH and μ={0,1,2,3,5,6} for other channels. Normal CP is supported for all sub-carrier spacings, extended CP is supported for μ=2. 12 consecutive sub-carriers form a PRB; up to 275 PRBs are supported on a carrier.

For subcarrier spacing (SCS) configuration, slots are numbered

$${n}_{s}^{μ} ∈ \{ 0 , … , {N}_{slot}^{subframe , μ} - 1 \}$$

in increasing order within a subframe and

$${n}_{s , f}^{μ} ∈ \{ 0 , … , {N}_{slot}^{f r ame , μ} - 1 \}$$

in increasing order within a frame. There are

$${N}_{s y m b}^{slot}$$

consecutive OFDM symbols in a slot where

$${N}_{s y m b}^{slot}$$

depends on the cyclic prefix as given by Tables 4.3.2-1 and 4.3.2-2 of [TS38211]. The start of slot

$${n}_{s}^{μ}$$

in a subframe is aligned in time with the start of OFDM symbol

$${n}_{s}^{μ} {N}_{symb}^{slot}$$

in the same subframe. OFDM symbols in a slot in a DL or UL frame can be classified as ‘downlink’, ‘flexible’, or ‘uplink’. Signaling of slot formats is described in [TS38213]§ 11.1. In a slot in a DL frame, the UE 402 assume that downlink transmissions only occur in ‘downlink’ or ‘flexible’ symbols. In a slot in an UL frame, the UE 402 only transmits in ‘uplink’ or ‘flexible’ symbols.

A UE 402 not capable of full-duplex communication and not supporting simultaneous transmission and reception as defined by parameter simultaneousRxTxInterBandENDC, simultaneousRxTxInterBandCA or simultaneousRxTxSUL (see e.g., 3GPP TS 38.306) among all cells within a group of cells is not expected to transmit in the uplink in one cell within the group of cells earlier than N_{RX-TX}T_{c} after the end of the last received downlink symbol in the same or different cell within the group of cells where N_{RX-TX} is given by Table 4.3.2-3 of [TS38211]. A UE 402 not capable of full-duplex communication and not supporting simultaneous transmission and reception as defined by parameter simultaneousRxTxlnterBandENDC, simultaneousRxTxInterBandCA or simultaneousRxTxSUL (see e.g., 3GPP TS 38.306) among all cells within a group of cells is not expected to receive in the downlink in one cell within the group of cells earlier than N_{TX-RX}T_{c} after the end of the last transmitted uplink symbol in the same or different cell within the group of cells where N_{TX-RX} is given by Table 4.3.2-3 of [TS38211].

For DAPS handover operation, a UE 402 not capable of full-duplex communication is not expected to transmit in the uplink to a cell earlier than N_{RX-TX}T_{c} after the end of the last received downlink symbol in the different cell where N_{RX-TX} is given by Table 4.3.2-3. For DAPS handover operation, a UE 402 not capable of full-duplex communication is not expected to receive in the downlink from a cell earlier than N_{TX-RX}T_{c} after the end of the last transmitted uplink symbol in the different cell where N_{TX-RX} is given by Table 4.3.2-3 of [TS38211].

A UE 402 not capable of full-duplex communication is not expected to transmit in the uplink earlier than N_{Rx-Tx}T_{c} after the end of the last received downlink symbol in the same cell where N_{RX-Tx} is given by Table 4.3.2-3 of [TS38211]. A UE 402 not capable of full-duplex communication is not expected to receive in the downlink earlier than N_{Tx-Rx}T_{c}, after the end of the last transmitted uplink symbol in the same cell where N_{TX-RX} is given by Table 4.3.2-3 of [TS38211].

An antenna port is defined such that the channel over which a symbol on the antenna port is conveyed can be inferred from the channel over which another symbol on the same antenna port is conveyed. Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

For each numerology and carrier, a resource grid of

$${N}_{grid , x}^{size , μ} {N}_{sc}^{RE}$$

subcarriers and

$${N}_{symb}^{subframe , μ}$$

OFDM symbols is defined, starting at common resource block (CRB)

$${N}_{grid}^{start , μ}$$

indicated by higher-layer signalling. There is one set of resource grids per transmission direction (UL, DL, or SL) with the subscript x set to DL, UL, and SL for downlink, uplink, and sidelink, respectively. When there is no risk for confusion, the subscript x may be dropped. There is one resource grid for a given antenna port p, SCS configuration p, and transmission direction (UL, DL, or SL).

For UL and DL, the carrier bandwidth

$${N}_{grid}^{size , μ}$$

for SCS configuration μ is given by the higher-layer parameter carrierBandwidth in the SCS-SpecificCarrier IE. The starting position

$${N}_{grid}^{start , μ}$$

for SCS configuration μ is given by the higher-layer parameter offsetToCarrier in the SCS-SpecificCarrier IE.

The frequency location of a subcarrier refers to the center frequency of that subcarrier. For the DL, the higher-layer parameter txDirectCurrentLocation in the SCS-SpecificCarrier IE indicates the location of the transmitter DC subcarrier in the downlink for each of the numerologies configured in the downlink. Values in the range 0-3299 represent the number of the DC subcarrier and the value 3300 indicates that the DC subcarrier is located outside the resource grid. For the UL, the higher-layer parameter txDirectCurrentLocation in the UplinkTxDirectCurrentBWP IE indicates the location of the transmitter DC subcarrier in the uplink for each of the configured bandwidth parts (BWPs), including whether the DC subcarrier location is offset by 7.5 kHz relative to the center of the indicated subcarrier or not. Values in the range 0-3299 represent the number of the DC subcarrier, the value 3300 indicates that the DC subcarrier is located outside the resource grid, and the value 3301 indicates that the position of the DC subcarrier in the uplink is undetermined.

Each element in the resource grid for antenna port p and SCS configuration μ is called a resource element and is uniquely identified by (k, l)_{p,μ} where k is the index in the frequency domain and l refers to the symbol position in the time domain relative to some reference point. Resource element (k, l)p,μ corresponds to a physical resource and the complex value

$${a}_{k , l}^{( p , μ )} .$$

When there is no risk for confusion, or no particular antenna port or SCS is specified, the indices μ and μ may be dropped, resulting in

$${a}_{k , l}^{( p )}$$

or a_{k,l}. A resource block (RB) is defined as

$${N}_{sc}^{RB} = 12$$

consecutive subcarriers in the frequency domain. Point A serves as a common reference point for resource block grids and is obtained from: offsetToPointA for a PCell downlink where offsetToPointA represents the frequency offset between point A and the lowest subcarrier of the lowest resource block, which overlaps with the SS/PBCH block used by the UE 402 for initial cell selection, expressed in units of resource blocks assuming 15 kHz SCS for FR1 and 60 kHz SCS for FR2; for operation without shared spectrum channel access in FR1 and FR2-1, the lowest resource block has the SCS provided by the higher layer parameter subCarrierSpacingCommon; for operation with shared spectrum channel access in FR1 or FR2, and for operation without shared spectrum channel access in FR2-2, the lowest resource block has the SCS same as the SS/PBCH block used by the UE 402 for initial cell selection; absoluteFrequencyPointA for all other cases where absoluteFrequencyPointA represents the frequency-location of point A expressed as in ARFCN.

CRBs are numbered from 0 and upwards in the frequency domain for SCS configuration p. The center of subcarrier 0 of CRB 0 for SCS configuration μ coincides with ‘point A’. The relation between the CRB number

$${n}_{CRB}^{μ}$$

in the frequency domain and resource elements (k, l) for SCS configuration μ is given by

$${n}_{CRB}^{μ} = ⌊ \frac{k}{{N}_{sc}^{RB}} ⌋ ,$$

where k is defined relative to point A such that k=0 corresponds to the subcarrier centered around point A. Physical resource blocks (PRBs) for SCS configuration μ are defined within a BWP and numbered from 0 to

$${N}_{BWP , i}^{size , μ} - 1$$

where i is the number of the BWP. The relation between the physical resource block

$${n}_{PRB}^{μ}$$

### in BWP i and the CRB

$${n}_{CRB}^{μ}$$

is given by

$${n}_{CRB}^{μ} = {n}_{PRB}^{μ} + {N}_{BWP , i}^{start , μ}$$

where

$${N}_{BWP , i}^{start , μ}$$

is the CRB where BWP i starts relative to CRB 0. When there is no risk for confusion the index μ may be dropped. Virtual resource blocks (VRBs) are defined within a BWP and numbered from 0 to

$${N}_{BWP , i}^{start} - 1$$

where i is the number of the BWP. Multiple interlaces of resource blocks are defined where interlace m∈{0,1, . . . , M−1} includes CRBs {m, M+m, 2M+m, 3M+m, . . . }, with M being the number of interlaces. The relation between the interlaced resource block

$${n}_{IRR , m}^{μ} ∈ \{ 0 , 1 , … \}$$

### in BWP i and

interlace m and the CRB

$${n}_{CRB}^{μ}$$

is given by:

$${n}^{{ }_{RB}} = {Mn}_{IRB , m}^{μ} + {N}_{BWP , i}^{startμ} + ( ( m - {N}_{BWP , i}^{start , μ} ) mod M ) ,$$

where

$${N}_{BWP , i}^{start}$$

is the CRB where BWP starts relative to CRB 0. When there is no risk for confusion the index μ may be dropped. The UE 402 expects that the number of CRBs in an interlace contained within BWP i is no less than 10.

The UE 402 may be configured with one or more bandwidth parts (BWPs) on a given CC, of which only one can be active at a time, as described in [TS38300]§§ 7.8 and 6.10, respectively. The active BWP defines the UE's 402 operating bandwidth within the cell's operating bandwidth. For initial access, and until the UE's 402 configuration in a cell is received, initial bandwidth part detected from system information is used. The 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (e.g., PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load. A BWP is a subset of contiguous CRBs defined in [TS38211]§ 4.4.4.3 for a given numerology μᵢ in BWP i on a given carrier. The starting position

$${N}_{BWP , i}^{start}$$

and the number of resource blocks

$${N}_{BWP , i}^{start}$$

in a BWP fulfills

$${N}_{grid , x}^{start , μ} \leq {N}_{BWP , i}^{size , μ} < {N}_{grid , x}^{start , μ} + {N}_{grid , x}^{start , μ} and {N}_{BWP , i}^{size , μ} \leq {N}_{grid , x}^{start , μ} + {N}_{grid , x}^{size , μ} ,$$

respectively. Configuration of a BWP is described in [TS38213]§ 12. A UE 402 can be configured with up to four BWPs in the DL with a single downlink BWP being active at a given time. The UE 402 is not expected to receive PDSCH, PDCCH, or CSI-RS (except for RRM) outside an active BWP. A UE 402 can be configured with up to four BWPs in the UL with a single uplink BWP being active at a given time. If a UE 402 is configured with a supplementary uplink, the UE can in addition be configured with up to four BWPs in the supplementary uplink with a single supplementary uplink BWP being active at a given time. The UE does not transmit PUSCH or PUCCH outside an active BWP. For an active cell, the UE 402 does not transmit SRS outside an active BWP. Unless otherwise noted, the description in this specification applies to each of the BWPs. When there is no risk of confusion, the index μ may be dropped from

$${N}_{BWP , i}^{start , μ} , {N}_{BWP , i}^{size , μ} , {N}_{grid , x}^{start , μ} , and {N}_{grid ,}^{size , μ} .$$

W.r.t CA, transmissions in multiple cells can be aggregated. Unless otherwise noted, the description in this specification applies to each of the serving cells. For CA of cells with unaligned frame boundaries, the slot offset

$${N}_{slot}^{CA}$$

between a PCell/Primary SCell (PSCell) and an SCell is determined by higher-layer parameter ca-SlotOffset for the SCell. The quantity μ_{offset} is defined as the maximum of the lowest SCS configuration among the SCSs given by the higher-layer parameters scs-SpecificCarrierList configured for PCell/PSCell and the SCell, respectively. The slot offset

$${N}_{slot , offset}^{CA}$$

fulfills when the lowest SCS configuration among the SCSs configured for the cell is μ=2 for both cells or μ=3 for both cells, the start of slot 0 for the cell whose point A has a lower frequency coincides with the start of slot

$${qN}_{slot , offset}^{CA} mod {N}_{slot}^{frame , {μ}_{offset}}$$

for the other cell where q=−1 if point A of the PCell/PSCell has a frequency lower than the frequency of point A for the SCell, otherwise q=1; otherwise, the start of slot 0 for the cell with the lower SCS of the lowest SCS given by the higher-layer parameters scs-SpecificCarrierList configured for the two cells, or the PCell/PSCell if both cells have the same lowest SCS given by the higher-layer parameters scs-SpecificCarrierList configured for the two cells, coincides with the start of slot

$${qN}_{slot , offset}^{CA} mod {N}_{slot}^{frame , {μ}_{offset}}$$

for the other cell where q=−1 if the lowest subcarreier spacing configuration given by scs-SpecificCarrierList of the PCell/PSCell is smaller than or equal to the lowest SCS given by scs-SpecificCarrierList for the SCell, otherwise q=1.

The PDCCH can be used to schedule DL transmissions on PDSCH and UL transmissions on PUSCH, where the DCI on PDCCH includes DL assignments containing at least modulation and coding format, resource allocation, and hybrid-ARQ information related to DL-SCH; and/or UL scheduling grants containing at least modulation and coding format, resource allocation, and hybrid-ARQ information related to UL-SCH. In addition to scheduling, PDCCH can be used to for: activation and deactivation of configured PUSCH transmission with configured grant; activation and deactivation of PDSCH semi-persistent transmission; activation of one or more CSI/measurement configurations and/or triggering CSI/measurement reporting according to the various implementations discussed herein; notifying one or more UEs 402 of the slot format; notifying one or more UEs 402 of the PRB(s) and OFDM symbol(s) where the UE 402 may assume no transmission is intended for the UE 402; transmission of TPC commands for PUCCH and PUSCH; transmission of one or more TPC commands for SRS transmissions by one or more UEs 402; switching a UE's 402 active BWP; initiating a random access procedure; indicating the UE(s) 402 to monitor the PDCCH during the next occurrence of the DRX on-duration; in IAB context, indicating the availability for soft symbols of an IAB-DU; triggering one shot HARQ-ACK codebook feedback; and for operation with shared spectrum channel access: triggering search space set group switching; indicating one or more UEs 402 about the available RB sets and channel occupancy time duration; and indicating downlink feedback information for configured grant PUSCH (CG-DFI). Polar coding is used for PDCCH. Each RE group carrying PDCCH carries its own DMRS. QPSK modulation is used for PDCCH.

The UE 402 monitors a set of PDCCH candidates in the configured monitoring occasions in one or more configured COntrol REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET. The PDCCH repetition is operated by using two search spaces which are explicitly linked by configuration provided by the RRC layer, and are associated with corresponding CORESETs. For PDCCH repetition, two linked search spaces are configured with the same number of candidates, and two PDCCH candidates in two search spaces are linked with the same candidate index. When PDCCH repetition is scheduled to a UE 402, an intra-slot repetition is allowed and each repetition has the same number of CCEs and coded bits, and corresponds to the same DCI payload.

The PUCCH carries UL control information (UCI) from the UE 402 to the RAN node 414 (e.g., gNB 414a). Five formats of PUCCH exist, depending on the duration of PUCCH and the UCI payload size: Format #0: Short PUCCH of 1 or 2 symbols with small UCI payloads of up to two bits with UE multiplexing capacity of up to 6 UEs with 1-bit payload in the same PRB; Format #1: Long PUCCH of 4-14 symbols with small UCI payloads of up to two bits with UE multiplexing capacity of up to 84 UEs without frequency hopping and 36 UEs with frequency hopping in the same PRB; Format #2: Short PUCCH of 1 or 2 symbols with large UCI payloads of more than two bits with no UE multiplexing capability in the same PRBs; Format #3: Long PUCCH of 4-14 symbols with large UCI payloads with no UE multiplexing capability in the same PRBs; and Format #4: Long PUCCH of 4-14 symbols with moderate UCI payloads with multiplexing capacity of up to 4 UEs 402 in the same PRBs.

W.r.t PDCCH monitoring indication and dormancy/non-dormancy behavior for SCells, a UE 402 configured with DRX mode operation (see e.g., 3GPP TS 38.321 (“[TS38321]”)) can be provided the following for detection of a DCI format 2_6 in a PDCCH reception on a PCell or on an SpCell (see e.g., [TS38331]): a PS-RNTI for DCI format 2_6 by ps-RNTI; a number of search space sets, by dci-Format2-6, to monitor PDCCH for detection of DCI format 2_6 on the active DL BWP of the PCell or of the SpCell according to a common search space as described in [TS38213]§ 10.1; a payload size for DCI format 2_6 by sizeDCI-2-6; a location in DCI format 2_6 of a Wake-up indication bit by ps-PositionDCI-2-6 wherein a ‘0’ value for the Wake-up indication bit, when reported to higher layers, indicates to not start the drx-onDurationTimer for the next long DRX cycle (see e.g., [TS38321]) and a ‘1’ value for the Wake-up indication bit, when reported to higher layers, indicates to start the drx-onDurationTimer for the next long DRX cycle (see e.g., [TS38321]); a bitmap, when the UE 402 is provided a number of groups of configured SCells by dormancyGroupOutsideActiveTime, where the bitmap location is immediately after the Wake-up indication bit location, the bitmap size is equal to the number of groups of configured SCells where each bit of the bitmap corresponds to a group of configured SCells from the number of groups of configured Scells, a ‘0’ value for a bit of the bitmap indicates an active DL BWP, provided by dormantBWP-Id, for the UE 402 (see e.g., [TS38321]) for each activated SCell in the corresponding group of configured Scells, a ‘1’ value for a bit of the bitmap indicates an active DL BWP, provided by firstOutsideActiveTimeBWP-Id, for the UE 402 for each activated SCell in the corresponding group of configured SCells, if a current active DL BWP is the dormant DL BWP and/or a current active DL BWP, for the UE 402 for each activated SCell in the corresponding group of configured SCells, if the current active DL BWP is not the dormant DL BWP, and the UE 402 sets the active DL BWP to the indicated active DL BWP; an offset by ps-Offset indicating a time, where the UE 402 starts monitoring PDCCH for detection of DCI format 2_6 according to the number of search space sets, prior to a slot where the drx-onDurationTimer would start on the PCell or on the SpCell (see e.g., [TS38321]), for each search space set, the PDCCH monitoring occasions are the ones in the first Tₛ slots indicated by duration, or Tₛ=1 slot if duration is not provided, starting from the first slot of the first Tₛ slots and ending prior to the start of drx-onDurationTimer.

On PDCCH monitoring occasions associated with a same long DRX cycle, a UE 402 does not expect to detect more than one DCI format 2_6 with different values of the wake-up indication bit for the UE 402 or with different values of the bitmap for the UE 402. The UE 402 does not monitor PDCCH for detecting DCI format 2_6 during active time (see e.g., [TS38321]). If a UE 402 reports for an active DL BWP a MinTimeGap value that is X slots prior to the beginning of a slot where the UE 402 would start the drx-onDurationTimer, the UE 402 is not required to monitor PDCCH for detection of DCI format 2_6 during the X slots, where X corresponds to the MinTimeGap value of the SCS of the active DL BWP in table 2-1.

TABLE 2-1
Minimum time gap value X

| | |
|---|---|
| SCS | Minimum Time Gap X (slots) |

| (kHz) | Value 1 | Value 2 |
|---|---|---|
| 15 | 1 | 3 |
| 30 | 1 | 6 |
| 60 | 1 | 12 |
| 120 | 2 | 24 |
| 480 | 8 | 96 |
| 960 | 16 | 192 |

If a UE 402 is provided search space sets to monitor PDCCH for detection of DCI format 2_6 in the active DL BWP of the PCell or of the SpCell and the UE 402 detects DCI format 2_6, the physical layer (PHY) of a UE 402 reports the value of the wake-up indication bit for the UE 402 to higher layers (see e.g., [TS38321]) for the next long DRX cycle.

If a UE 402 is provided search space sets to monitor PDCCH for detection of DCI format 2_6 in the active DL BWP of the PCell or of the SpCell and the UE 402 does not detect DCI format 2_6, the PHY of the UE 402 does not report a value of the Wake-up indication bit to higher layers for the next long DRX cycle.

If a UE 402 is provided search space sets to monitor PDCCH for detection of DCI format 2_6 in the active DL BWP of the PCell or of the SpCell and the UE 402 is not required to monitor PDCCH for detection of DCI format 26, as described in [TS38213]§§ 10, 11.1, 12, and in clause 5.7 of [TS38321] for all corresponding PDCCH monitoring occasions outside active time prior to a next long DRX cycle, and/or does not have any PDCCH monitoring occasions for detection of DCI format 2_6 outside active time of a next long DRX cycle, the PHY of the UE 402 reports a value of 1 for the wake-up indication bit to higher layers for the next long DRX cycle.

If a UE 402 is provided search space sets to monitor PDCCH for detection of DCI format 0_1 and DCI format 1_1 and if one or both of DCI format 0_1 and DCI format 1_1 include a SCell dormancy indication field, the SCell dormancy indication field is a bitmap with size equal to a number of groups of configured SCells, provided by dormancyGroupWithinActiveTime; each bit of the bitmap corresponds to a group of configured SCells from the number of groups of configured SCells; if the UE 402 detects a DCI format 0_1 or a DCI format 1_1 that does not include a carrier indicator field, or detects a DCI format 0_1 or DCI format 1_1 that includes a carrier indicator field with value equal to 0, and if the DCI format 0_1 does not indicate UL grant Type 2 release nor deactivate semi-persistent CSI report(s) on PUSCH, or if the DCI format 1_1 does not indicate SPS PDSCH release, a ‘0’ value for a bit of the bitmap indicates an active DL BWP, provided by dormantBWP-Id, for the UE 402 for each activated SCell in the corresponding group of configured Scells and a ‘1’ value for a bit of the bitmap indicates an active DL BWP, provided by firstWithinActiveTimeBWP-Id, for the UE 402 for each activated SCell in the corresponding group of configured SCells, if a current active DL BWP is the dormant DL BWP and/or a current active DL BWP, for the UE 402 for each activated SCell in the corresponding group of configured SCells, if the current active DL BWP is not the dormant DL BWP; and/or the UE 402 sets the active DL BWP to the indicated active DL BWP.

If a UE 402 is provided search space sets to monitor PDCCH for detection of DCI format 1_1, and if the CRC of DCI format 1_1 is scrambled by a C-RNTI or a MCS-C-RNTI, and if a one-shot HARQ-ACK request field is not present or has a ‘0’ value, and if the UE 402 detects a DCI format 11 on the primary cell that does not include a carrier indicator field, or detects a DCI format 1_1 on the primary cell that includes a carrier indicator field with value equal to 0, and if resourceAllocation=resourceAllocationType0 and all bits of the frequency domain resource assignment field in DCI format 1_1 are equal to 0, and/or resourceAllocation=resourceAllocationType1 and all bits of the frequency domain resource assignment field in DCI format 1_1 are equal to 1, and/or resourceAllocation=dynamicSwitch and all bits of the frequency domain resource assignment field in DCI format 1_1 are equal to 0 or 1, the UE 402 considers the DCI format 1_1 as indicating SCell dormancy, not scheduling a PDSCH reception, and for transport block 1 interprets the sequence of fields of modulation and coding scheme, new data indicator, and/or redundancy version; and of HARQ process number, antenna port(s), and/or DMRS sequence initialization as providing a bitmap to each configured SCell, in an ascending order of the SCell index, where a ‘0’ value for a bit of the bitmap indicates an active DL BWP, provided by dormantBWP-Id, for the UE 402 for a corresponding activated SCell and a ‘1’ value for a bit of the bitmap indicates an active DL BWP, provided by firstWithinActiveTimeBWP-Id, for the UE 402 for a corresponding activated SCell, if a current active DL BWP is the dormant DL BWP and/or a current active DL BWP, for the UE 402 for a corresponding activated SCell, if the current active DL BWP is not the dormant DL BWP, and the UE 402 sets the active DL BWP to the indicated active DL BWP.

If an active DL BWP provided by dormantBWP-Id for a UE 402 on an activated SCell is not a default DL BWP for the UE 402 on the activated SCell, as described in clause 12, the BWP inactivity timer is not used for transitioning from the active DL BWP provided by dormantBWP-Id to the default DL BWP on the activated SCell.

A UE 402 is expected to provide HARQ-ACK information in response to a detection of a DCI format 1_1 indicating SCell dormancy after N symbols from the last symbol of a PDCCH providing the DCI format 1_1. If processingType2Enabled of PDSCH-ServingCellConfig is set to enable for the serving cell with the PDCCH providing the DCI format 1_1, N=7 for μ=0, N=7.5 for μ=1, and N=15 for t=2; otherwise, N=14 for μ=0, N=16 for μ=1, N=27 for μ=2, N=31 for μ=3, N=124 for μ=5, and =248 for μ=6, where μ is the smallest subscarrier spacing (SCS) configuration between the SCS configuration of the PDCCH providing the DCI format 1_1 and the SCS configuration of a PUCCH with the HARQ-ACK information in response to the detection of the DCI format 1_1.

Example RRC parameters relevant to WUS and/or wake-up indication are as follows: The parameter/field/IE ps-WakeUp indicates the UE 402 to wake-up if DCI format 2_6 is not detected outside active time (see e.g., [TS38321]§ 5.7). If ps-WakeUp field is absent, the UE 402 does not wake-up if DCI format 2_6 is not detected outside active time. The parameter/field/IE ps-PositionDCI-2-6 indicates a starting position of UE wakeup and SCell dormancy indication in DCI format 2-6 (see e.g., [TS38321]§ 10.3).

The RAN 404 is communicatively coupled to CN 420 that includes network elements and/or network functions (NFs) to provide various functions to support data and telecommunications services to customers/subscribers (e.g., UE 402). The components of the CN 420 may be implemented in one physical node or separate physical nodes. In some examples, NFV may be utilized to virtualize any or all of the functions provided by the network elements of the CN 420 onto physical compute/storage resources in servers, switches, and the like. A logical instantiation of the CN 420 may be referred to as a network slice, and a logical instantiation of a portion of the CN 420 may be referred to as a network sub-slice. In the example of FIG. 4, the CN 440 is a 5GC 440 including an Authentication Server Function (AUSF) 442, Access and Mobility Management Function (AMF) 444, Session Management Function (SMF) 446, User Plane Function (UPF) 448, Network Slice Selection Function (NSSF) 450, Network Exposure Function (NEF) 452, Network Repository Function (NRF) 454, Policy Control Function (PCF) 456, Unified Data Management (UDM) 458, Unified Data Repository (UDR), Application Function (AF) 460, and Network Data Analytics Function (NWDAF) 462 coupled with one another over various interfaces as shown. Various aspects of the various NFs in the 5GC 440 are discussed in detail in '509, '797, and [TS23501], among many other 3GPP standards/specifications.

Although not shown by FIG. 4, the system 400 may also include NFs that are not shown such as, for example, any of those discussed in [TS23501] The data network (DN) 436, at least in some examples, is a network hosting data-centric services such as, for example, operator services, the internet, third-party services, or enterprise networks. In some examples, the DN 436 includes one or more service networks that belong to an operator or third party, which are offered as a service to a client or UE 402. Additionally or alternatively, the DN 436 is provided by one or more servers including, for example, application (app)/content server 438, edge servers and/or edge compute nodes, cloud computing services, and/or the like. The DN 436 may be an operator external public, a private PDN, or an intra-operator packet data network, for example, for provision of IMS services. In this example, the app server 438 can be coupled to an IMS via an S-CSCF or the I-CSCF. In some implementations, the DN 436 may represent one or more local area DNs (LADNs), which are DNs 436 (or DN names (DNNs)) that is/are accessible by a UE 402 in one or more specific areas. Outside of these specific areas, the UE 402 is not able to access the LADN/DN 436. Additionally or alternatively, the DN 436 may be an edge DN 436, which is a (local) DN that supports the architecture for enabling edge applications. In these examples, the app server 438 may represent the physical hardware systems/devices providing app server functionality and/or the application software resident in the cloud or at an edge compute node that performs server function(s). In some examples, the app/content server 438 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 404 or RAN nodes 414. For example, the edge compute nodes can provide a connection between the RAN 404 and UPF 448 in the 5GC 440. The edge compute nodes can use one or more NFV instances instantiated on virtualization infrastructure within the edge compute nodes to process wireless connections to and from the RAN 414 and UPF 448. The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 402. The VI of the edge compute nodes provide virtualized environments and virtualized resources for the edge hosts, and the edge computing applications may run as VMs and/or application containers on top of the VI. Examples of the edge computing frameworks/ECTs and services deployment examples that can be used are discussed in '509 and '797.

The interfaces of the 5GC 440 include reference points and service-based interfaces. A reference point, at least in some examples, is a point at the conjunction of two non-overlapping functional groups, elements, or entities. The reference points in the 5GC 440 include: N1, N2, N3, N4, N5, N6, N7, N8, N9, N10, N11, N12, N13, N14 (between two AMFs 444; not shown), N15, N16, and N22. Other reference points not shown in FIG. 4 can also be used, such as any of those discussed in [TS23501]. The service-based representation of FIG. 4 represents NFs within the control plane that enable other authorized NFs to access their services. A service-based interface (SBI), at least in some examples, is an interface over which an NF can access the services of one or more other NFs. In some implementations, the service-based interfaces are API-based interfaces (e.g., HTTP/2, RESTful, SOAP, and/or any other API or web service) that can be used by an NF to call or invoke a particular service or service operation. The SBIs in the 5GC 440 include: Namf, Nsmf, Nnef, Npcf, Nudm, Naf, Nnrf, Nnssf, Nausf. Other service-based interfaces (e.g., Nudr, N5g-eir, and Nudsf) not shown in FIG. 4 can also be used, such as any of those discussed in [TS23501].

FIG. 5 schematically illustrates a wireless network 500. The wireless network 500 includes a UE 502 in wireless communication with a NAN 504. The UE 402 may be the same or similar to UE 402 of FIGS. 1-4 and NAN 504 may be the same or similar to the RAN node 414 of FIGS. 1-4.

The UE 502 can communicatively couple with the NAN 504 via connection 506. The connection 506 is an air interface to enable communicative coupling, and can be consistent with cellular communications protocols (e.g., LTE, 5G/NR, mmWave or sub-6 GHz frequencies, and/or any other access network protocol). The connection 506 may correspond to the Uu interface described w.r.t FIG. 4.

The UE 502 includes a host platform 508 coupled with a modem platform 510. The host platform 508 includes application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations includes transport (e.g., UDP, QUIC, TCP, and/or the like) and network (e.g., IP and/or the like) operations. The protocol processing circuitry 514 may implement one or more of layer operations to facilitate transmission or reception of data over the connection 506. The layer operations implemented by the protocol processing circuitry 514 includes, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations includes, for example, PHY operations including one or more of HARQ functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and/or other related functions, including any of those discussed herein and/or in 3GPP TS 36.201, 3GPP TS 38.201, [TS38211], [TS38212], [TS38213], [TS38214], and/or any other standards/specifications, including any of those mentioned herein. In some examples, the protocol processing circuitry 514 includes one or more instances of control circuitry (not shown) to provide control functions for the transmit/receive components.

The modem platform 510 includes transmit circuitry 518, receive circuitry 520, RF circuitry 522, and RF front end (RFFE) 524, which includes or connect to one or more antenna panels 526. Briefly, the transmit circuitry 5 518 includes a digital-to-analog converter, mixer, intermediate frequency (IF) components; the receive circuitry 520 includes an analog-to-digital converter, mixer, IF components; the RF circuitry 522 includes a low-noise amplifier, a power amplifier, power tracking components, etc.; RFFE 524 includes filters (for example, surface/bulk acoustic wave filters), switches, antenna tuners, beamforming components (for example, phase-array antenna components), and/or the like. The selection and arrangement of the components of the transmit circuitry 518, receive circuitry 520, RF circuitry 522, RFFE 524, and antenna panels 526 may be specific to details of a specific implementation such as, for example, whether communication is TDM or FDM, in mmWave or sub-6 gHz frequencies, etc. In some examples, the transmit/receive components may be arranged in multiple parallel transmit/receive chains, may be disposed in the same or different chips/modules, etc.

A UE reception may be established by and via the antenna panels 526, RFFE 524, RF circuitry 522, receive circuitry 520, digital baseband circuitry 516, and protocol processing circuitry 514. In some examples, the antenna panels 526 may receive a transmission from the AN 504 by receive-beamforming signals received by a plurality of antennas/antenna elements of the one or more antenna panels 526. A UE transmission may be established by and via the protocol processing circuitry 514, digital baseband circuitry 516, transmit circuitry 518, RF circuitry 522, RFFE 524, and antenna panels 526. In some examples, the transmit components of the UE 504 may apply a spatial filter to the data to be transmitted to form a transmit beam emitted by the antenna elements of the antenna panels 526.

Similar to the UE 502, the NAN 404 includes a host platform 528 coupled with a modem platform 530. The host platform 528 includes application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the NAN 404 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling. Examples of the antenna elements of the antenna panels 526 and/or the antenna elements of the antenna panels 546 include planar inverted-F antennas (PIFAs), monopole antennas, dipole antennas, loop antennas, patch antennas, Yagi antennas, parabolic dish antennas, omni-directional antennas, and/or the like.

FIG. 6 illustrates components capable of reading instructions from a machine-readable or computer-readable medium (e.g., a non-transitory machine-readable storage medium) and perform any one or more of the methodologies discussed herein. Specifically, FIG. 6 shows hardware resources 600 including one or more processors (or processor cores) 610, one or more memory/storage devices 620, and one or more communication resources 630, each of which may be communicatively coupled via a bus 640 or other interface circuitry. For examples where node virtualization (e.g., NFV) is utilized, a hypervisor 602 may be executed to provide an execution environment for one or more network slices/sub-slices to utilize the hardware resources 600. In some examples, the hardware resources 600 may be implemented in or by an individual compute node, which may be housed in an enclosure of various form factors. In other examples, the hardware resources 600 may be implemented by multiple compute nodes that may be deployed in one or more data centers and/or distributed across one or more geographic regions.

The processors 610 may include, for example, a processor 612 and a processor 614. The processors 610 may be or include, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

The memory/storage devices 620 may include main memory, disk storage, or any suitable combination thereof. The memory/storage devices 620 may include, but are not limited to, any type of volatile, non-volatile, semi-volatile memory, and/or any combination thereof. As examples, the memory/storage devices 620 can be or include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, and/or a combination of any of the aforementioned memory devices, and/or other memory.

The communication resources 630 may include interconnection or network interface controllers, components, or other suitable devices to communicate with one or more peripheral devices 604 or one or more databases 606 or other network elements via a network 608. For example, the communication resources 630 may include wired communication components (e.g., for coupling via USB, Ethernet, and/or the like), cellular communication components, NFC components, Bluetooth® (or Bluetooth® Low Energy) components, Wi-Fi® components, and other communication components.

Instructions 650 comprise software, program code, application(s), applet(s), an app(s), firmware, microcode, machine code, and/or other executable code for causing at least any of the processors 610 to perform any one or more of the methodologies and/or techniques discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

In some examples, the peripheral devices 604 may represent one or more sensors such as, for example, exteroceptive sensors, proprioceptive sensors, and/or exproprioceptive sensors (e.g., sensors that capture, measure, or correlate internal states and external states). Examples of such sensors include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors/thermistors; pressure sensors; barometric pressure sensors; gravimeters; altimeters; image sensors/cameras; light detection and ranging (LiDAR) sensors; proximity sensors; depth sensors, ambient light sensors; optical light sensors; ultrasonic transceivers; microphones; and the like.

Additionally or alternatively, the peripheral devices 604 may represent one or more actuators such as, for example, soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors (e.g., those discussed previously), clutches, and the like), projectile actuators/mechanisms (e.g., mechanisms that shoot or propel objects or elements), and/or audible sound generators, visual warning devices, and/or other like electromechanical components.

### 3. Example Implementations

FIG. 7 shows an example process 700 to be performed by an LR 110 in a UE 402. The process 700 includes determining that at least one criterion has been met for performing measurement of an LP-WUS 101 (701); and performing at least one measurement of an LP-WUS 101 when the at least one criterion has been met (702).

FIG. 8 shows an example process 800 to be performed by an MR 105 in a UE 402. The process 800 includes determining that at least one criterion has been met for performing measurement of an LP-WUS 101 (801); causing an LR 110 to perform at least one measurement of an LP-WUS 101 when the at least one criterion has been met (802); and performing at least one other measurement when the at least one criterion is not met or when at least one other criterion is met (803). In some examples, the at least one other measurement is a synchronization signal block (SSB) measurement and/or a channel state information reference signal (CSI-RS) measurement.

The example operations of processes 700-800 can be arranged in different orders, one or more of the depicted operations may be combined and/or divided/split into multiple operations, depicted operations may be omitted, and/or additional or alternative operations may be included in any of the depicted processes. Additional examples of the presently described methods, devices, systems, and networks discussed herein include the following, non-limiting example implementations. Each of the following non-limiting examples may stand on its own or may be combined in any permutation or combination with any one or more of the other examples provided below or throughout the present disclosure Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method for measurement based on low power wake-up signal (LP-WUS).

Example 2 includes the method of example 1 and/or some other example(s) herein, wherein the method includes activating the measurement based on LP-WUS if certain criterion is met, and deactivating the measurement based on LP-WUS if the certain criterion is not met.

Example 3 includes the method of example 2 and/or some other example(s) herein, wherein the certain criterion is evaluated by main radio and/or LP-WUR.

Example 4 includes the method of examples 2-3 and/or some other example(s) herein, wherein the method includes reporting to gNB upon the activation or deactivation of measurement based on LP-WUS.

Example 5 includes the method of examples 3-4 and/or some other example(s) herein, wherein the method includes extending the measurement period for the measurement by the main radio and/or LP-WUR if the measurement based on LP-WUS is activated.

Example 6 includes the method of examples 3-4 and/or some other example(s) herein, wherein the method includes reducing the number of samples for the measurement by the main radio and/or LP—if the measurement based on LP-WUS is activated.

Example 7 includes the method of examples 1-6 and/or some other example(s) herein, wherein the measurement is RRM measurement, RLM measurement, and/or beam measurement.

Example 8 includes the method of examples 1-7 and/or some other example(s) herein, wherein the measurement is for serving cell or neighbor cell measurement(s).

Example 9 includes the method of examples 1-8 and/or some other example(s) herein, wherein measurement based on LP-WUS includes one or more of RSRP, RSRQ, SNR, SINR, and/or any other metric for channel quality and/or interference quality discussed herein.

Example 10 includes the method of examples 1-30 and/or some other example(s) herein, wherein the method is performed by a user equipment (UE).

Example 11 includes a method of operating a low power wake-up signal radio (LR), comprising: determining that at least one criterion has been met; and performing at least one measurement of a low power wake up signal (LP-WUS) when the at least one criterion has been met.

Example 12 includes the method of example 11 and/or some other example(s) herein, wherein a main radio (MR) is to perform at least one other measurement when the at least one criterion is not met or when at least one other criterion is met.

Example 13 includes the method of example 12 and/or some other example(s) herein, wherein the determining that the at least one criterion has been met includes: receiving an indication from the MR that the at least one criterion has been met.

Example 14 includes a method of operating a main radio (MR), comprising: determining that at least one criterion has been met; and causing a low power wake-up signal radio (LR) to perform at least one measurement of a low power wake up signal (LP-WUS) when the at least one criterion has been met.

Example 15 includes the method of example 14 and/or some other example(s) herein, wherein the method includes: performing at least one other measurement when the at least one criterion is not met or when at least one other criterion is met.

Example 16 includes the method of examples 14-15 and/or some other example(s) herein, wherein the method includes: sending an indication to the LR that the at least one criterion has been met.

Example 17 includes the method of examples 12-16 and/or some other example(s) herein, wherein the at least one other measurement is a measurement of a synchronization signal block (SSB) or a channel state information reference signal (CSI-RS).

Example 18 includes the method of example 17 and/or some other example(s) herein, wherein the SSB is a non-cell defining (NCD) SSB or a cell defining (CD) SSB.

Example 19 includes the method of examples 12-18 and/or some other example(s) herein, wherein the method includes: activating the at least one measurement of the LP-WUS when the at least one criterion has been met; and deactivating the at least one measurement of the LP-WUS when the at least one criterion has not been met or when the at least one other criterion is met.

Example 20 includes the method of example 19 and/or some other example(s) herein, wherein the method includes: generating a report to indicate the activation or the deactivation of the at least one measurement of the LP-WUS; and transmitting the report to a network access node (NAN).

Example 21 includes the method of examples 19-20 and/or some other example(s) herein, wherein the method includes: extending a measurement period for performing the at least one measurement when the measurement of the LP-WUS is activated.

Example 22 includes the method of examples 19-21 and/or some other example(s) herein, wherein the method includes: causing the LR to monitor for a paging signal when the at least one measurement of the LP-WUS is deactivated.

Example 23 includes the method of examples 19-22 and/or some other example(s) herein, wherein the at least one other measurement is performed is a relaxed measurement when the at least one measurement based on LP-WUS is activated.

Example 24 includes the method of example 23 and/or some other example(s) herein, wherein the relaxed measurement includes a reduced measurement period for performing the at least one other measurement or a reduced number of measurement samples to be collected during a measurement period for performing the at least one other measurement.

Example 25 includes the method of examples 11-24 and/or some other example(s) herein, wherein the at least one criterion includes one or more criteria selected from a group comprising: the UE being configured to perform LP-WUS measurement, the UE being in a low mobility condition, the UE being in a not-at-cell-edge condition, the UE being in a good serving cell quality condition, and the UE not being in a discontinuous reception (DRX) on duration.

Example 26 includes the method of examples 11-25 and/or some other example(s) herein, wherein the at least one criterion includes one or more criteria selected from a group comprising: the at least one measurement being above or below a threshold, the at least one other measurement being above or below a threshold, a detection rate of the at least one measurement being above or below a threshold, a detection rate of the at least one other measurement being above or below a threshold, an error rate of the at least one measurement being above or below a threshold, an error rate of the at least one other measurement being above or below a threshold, a measurement of a serving cell being above or below a threshold, a measurement of a neighbor cell being above or below a threshold, an intra-frequency measurement being above or below a threshold, an inter-frequency measurement being above or below a threshold, a variation between at least two measurements being above or below a threshold, an average of measurements taken during a predefined or configured measurement period being above or below a threshold, a number of consecutive measurements being above or below a threshold, the UE being in a radio resource control (RRC) idle state, the UE being in an RRC inactive state, and the UE being in an RRC connected state.

Example 27 includes the method of examples 11-26 and/or some other example(s) herein, wherein the at least one measurement is a radio resource management (RRM) measurement, a radio link monitoring (RLM) measurement, or a beam failure detection (BFD) measurement.

Example 28 includes the method of examples 11-27 and/or some other example(s) herein, wherein the at least one measurement is a measurement of a serving cell, a measurement of at least one neighbor cells, an intra-frequency measurement, or an inter-frequency measurement.

Example 29 includes the method of examples 11-28 and/or some other example(s) herein, wherein the at least one measurement based on LP-WUS includes at least one reference signal received power (RSRP) measurement, at least one reference signal received quality (RSRQ) measurement, at least one signal-to-noise ratio (SNR) measurement, or at least one signal-to-noise and interference ratio (SINR) measurement.

Example 30 includes the method of examples 11-29 and/or some other example(s) herein, wherein the LR and the MR are implemented in a user equipment (UE).

Example 31 includes one or more computer readable media comprising instructions, wherein execution of the instructions by processor circuitry is to cause the processor circuitry to perform the method of examples 1-30.

Example 32 includes a computer program comprising the instructions of example 31.

Example 33 includes an Application Programming Interface defining functions, methods, variables, data structures, and/or protocols for the computer program of example 32.

Example 34 includes an API or specification defining functions, methods, variables, data structures, protocols, and the like, defining or involving use of any of examples 1-30 or portions thereof, or otherwise related to any of examples 1-30 or portions thereof.

Example 35 includes an apparatus comprising circuitry loaded with the instructions of example 31.

Example 36 includes an apparatus comprising circuitry operable to run the instructions of example 31.

Example 37 includes an integrated circuit comprising one or more of the processor circuitry of example 31 and the one or more computer readable media of example 31.

Example 38 includes a computing system comprising the one or more computer readable media and the processor circuitry of example 31.

Example 39 includes an apparatus comprising means for executing the instructions of example 31.

Example 40 includes a signal generated as a result of executing the instructions of example

31.

Example 41 includes a data unit generated as a result of executing the instructions of example 31.

Example 42 includes the data unit of example 40 and/or some other example(s) herein, wherein the data unit is a datagram, network packet, data frame, data segment, a Protocol Data Unit (PDU), a Service Data Unit (SDU), a message, or a database object.

Example 43 includes a signal encoded with the data unit of examples 41 and/or 42.

Example 44 includes an electromagnetic signal carrying the instructions of example 31.

Example 45 includes an apparatus comprising means for performing the method of examples 1-30 and/or some other example(s) herein.

Example 46 includes an edge compute node executing a service as part of one or more edge applications instantiated on virtualization infrastructure, the service being related to examples 1-30, portions thereof, and/or some other example(s) herein.

### 4. Terminology

For the purposes of the present document, the terminology discussed in '509 and '797 may be applicable to the examples and embodiments discussed herein. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another.

The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, engines, components, and so forth, or combinations thereof. The term “entity” at least in some examples refers to a distinct element of a component, architecture, platform, device, and/or system. Additionally or alternatively, the term “entity” at least in some examples refers to information transferred as a payload.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing. The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move.

The term “scheduler” at least in some examples refers to an entity or element that creates or generates a list of times, sequence(s), and/or an order in which tasks, events, actions, jobs, and/or the like are intended to take place. Additionally or alternatively, the term “scheduler” at least in some examples refers to an entity or element that schedules, coordinates, and/or manages tasks, events, actions, jobs, and/or the like to run or execute at specific times, under certain conditions or parameters, and/or based on (pre)defined or configured priorities. Additionally or alternatively, the term “scheduler” at least in some examples refers to an entity or element that assigns or otherwise manages resources and/or timings to perform tasks, events, actions, jobs, and/or the like. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like. The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” includes any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, extended reality (XR) devices, and/or other like systems or devices.

The term “station” or “STA” at least in some examples refers to a logical entity that is a singly addressable instance of a medium access control (MAC) and physical layer (PHY) interface to the wireless medium (WM).

The term “wireless medium” or WM” at least in some examples refers to the medium used to implement the transfer of protocol data units (PDUs) between peer physical layer (PHY) entities of a wireless local area network (LAN).

The term “Internet of Things” or “IoT” at least in some examples refers to a system of interrelated computing devices, mechanical and digital machines capable of transferring data with little or no human interaction, and may involve technologies, such as real-time analytics, AI/machine learning, embedded systems, wireless sensor networks, control systems, actuation, automation (e.g., smarthome, smart building and/or smart city technologies), and the like. In some examples, IoT devices are low-power devices without heavy compute or storage capabilities.

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like.

The term “network controller” at least in some examples refers to a functional block that centralizes some or all of the control and management functionality of a network domain and may provide an abstract view of the network domain to other functional blocks via an interface.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” includes specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRP), a gateway device (e.g., Residential Gateway, Wireline 5G Access Network, Wireline 5G Cable Access Network, Wireline BBF Access Network, and the like), network appliance, and/or some other network access hardware. The term “access point” or “AP” at least in some examples refers to an entity that contains one station (STA) and provides access to the distribution services, via the wireless medium (WM) for associated STAs. An AP comprises a STA and a distribution system access function (DSAF).

The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN.

The term “serving cell” at least in some examples refers to a primary cell (PCell) for a UE in a connected mode or state (e.g., RRC_CONNECTED) and not configured with carrier aggregation (CA) and/or dual connectivity (DC). Additionally or alternatively, the term “serving cell” at least in some examples refers to a set of cells comprising zero or more special cells and one or more secondary cells for a UE in a connected mode or state (e.g., RRC_CONNECTED) and configured with CA.

The term “primary cell” or “PCell” at least in some examples refers to a Master Cell Group (MCG) cell, operating on a primary frequency, in which a UE either performs an initial connection establishment procedure or initiates a connection re-establishment procedure.

The term “Secondary Cell” or “SCell” at least in some examples refers to a cell providing additional radio resources on top of a special cell (SpCell) for a UE configured with CA.

The term “special cell” or “SpCell” at least in some examples refers to a PCell for non-DC operation or refers to a PCell of an MCG or a PSCell of an SCG for DC operation.

The term “Master Cell Group” or “MCG” at least in some examples refers to a group of serving cells associated with a “Master Node” comprising a SpCell (PCell) and optionally one or more SCells.

The term “Secondary Cell Group” or “SCG” at least in some examples refers to a subset of serving cells comprising a Primary SCell (PSCell) and zero or more SCells for a UE configured with DC.

The term “Primary SCG Cell” refers to the SCG cell in which a UE performs random access when performing a reconfiguration with sync procedure for DC operation.

The term “handover” at least in some examples refers to the transfer of a user's connection from one radio channel to another (can be the same or different cell). Additionally or alternatively, the term “handover” at least in some examples refers to the process in which a radio access network changes the radio transmitters, radio access mode, and/or radio system used to provide the bearer services, while maintaining a defined bearer service QoS.

The term “Master Node” or “MN” at least in some examples refers to a NAN that provides control plane connection to a core network.

The term “Secondary Node” or “SN” at least in some examples refers to a NAN providing resources to the UE in addition to the resources provided by an MN and/or a NAN with no control plane connection to a core network.

The term “E-UTEAN NodeB”, “eNodeB”, or “eNB” at least in some examples refers to a RAN node providing E-UTRA user plane (e.g., PDCP, RLC, MAC, PHY) and control plane (e.g., RRC) protocol terminations towards a UE, and connected via an S1 interface to the Evolved Packet Core (EPC). Two or more eNBs are interconnected with each other (and/or with one or more en-gNBs) by means of an X2 interface.

The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340). Two or more en-gNBs are interconnected with each other (and/or with one or more eNBs) by means of an X2 interface.

The term “Next Generation RAN node” or “NG-RAN node” at least in some examples refers to either a gNB or an ng-eNB.

The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links.

The term “Transmission Reception Point” or “TRP” at least in some examples refers to an antenna array with one or more antenna elements available to a network located at a specific geographical location for a specific area.

The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs.

The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU.

The term “Radio Unit” or “RU” at least in some examples refers to a logical node hosting PHY layer or Low-PHY layer and radiofrequency (RF) processing based on a lower layer functional split.

The term “split architecture” at least in some examples refers to an architecture in which an CU, DU, and/or RU are physically separated from one another. Additionally or alternatively, the term “split architecture” at least in some examples refers to a RAN architecture such as those discussed in 3GPP TS 38.401, 3GPP TS 38.410, and 3GPP TS 38.473. The term “integrated architecture at least in some examples refers to an architecture in which an RU and DU are implemented on one platform, and/or an architecture in which a DU and a CU are implemented on one platform.

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network.

Examples of access technologies and/or RATs are discussed in '509 and '797.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “carrier” at least in some examples refers to a modulated waveform conveying one or more physical channels (e.g., 5G/NR, E-UTRA, UTRA, and/or GSM/EDGE physical channels). The term “carrier frequency” at least in some examples refers to the center frequency of a cell.

The term “bearer” at least in some examples refers to a information transmission path of defined capacity, delay, bit error rate, and/or the like. The term “radio bearer” at least in some examples refers to the service provided by Layer 2 (L2) for transfer of user data between user equipment (UE) and a radio access network (RAN). The term “radio access bearer” at least in some examples refers to the service that the access stratum provides to the non-access stratum for transfer of user data between a UE and a CN.

The terms “configuration”, “policy”, “ruleset”, and/or “operational parameters”, at least in some examples refer to a machine-readable information object that contains instructions, conditions, parameters, and/or criteria that are relevant to a device, system, or other element/entity.

Although many of the examples discussed herein are provided with use of specific cellular/mobile network terminology, including with the use of 4G/5G 3GPP network components (or expected terahertz-based 6G/6G+technologies), these examples may be applied to many other deployments of wide area and local wireless networks, as well as the integration of wired networks (including optical networks and associated fibers, transceivers, and/or the like). Furthermore, various standards (e.g, 3GPP, ETSI, IEEE, and/or the like) may define various message formats, PDUs, MAC CEs, containers, frames, and/or other data structures, as comprising a sequence of optional or mandatory containers, frames, data elements (DEs), data frames (DFs), information elements (IEs), information object classes (IOCs), managed object classes (MOCs), paramters, attributes, and/or other elements. However, the requirements of any particular standard should not limit the examples discussed herein, and as such, any combination of containers, frames, DFs, DEs, IEs, IOCs, MOCs, parameters, attributes, values, actions, features, and/or other elements are possible in various examples, including any combination of containers, frames, DFs, DEs, IEs, IOCs, MOCs, parameters, attributes, values, actions, features, and/or other elements that are strictly required to be followed in order to conform to such standards or any combination of containers, frames, DFs, DEs, IEs, IOCs, MOCs, parameters, attributes, values, actions, features, and/or other elements strongly recommended and/or used with or in the presence/absence of optional elements.

Moreover, the present disclosure provides various examples of names/labels for various systems, sub-systems, devices, planes, layers, protocols, components, operations, containers, frames, DFs, DEs, IEs, IOCs, MOCs, parameters, attributes, values, actions, features, and other elements/data structures. However, the specific names or labels used regarding the various systems, sub-systems, devices, planes, layers, components, operations, parameters, attributes, IEs, IOCs, MOCs, and other elements/data structures, are provided for the purpose of discussion and illustration, rather than limitation. The various systems, sub-systems, devices, planes, layers, components, operations, parameters, attributes, IEs, IOCs, MOCs, and other elements/data structures can have alternative names or labels to those provided herein. Furthermore, additional or alternative embodiments, implementations, and/or iterations of 3GPP specifications and/or other relevant standards/specifications may name certain elements/entities different to those discussed herein, but still fall within the context of the present disclosure.

Aspects of the inventive subject matter may be referred to herein, individually and/or collectively, merely for convenience and without intending to voluntarily limit the scope of this application to any single aspect or inventive concept. Although specific aspects have been shown and described herein, the present disclosure covers any and all adaptations or variations and any arrangement capable of achieving the same purpose may be substituted for the specific aspects shown and described herein. Combinations of the described aspects and other aspects not specifically described herein will be apparent to those of skill in the art upon reviewing the present disclosure.

What is claimed is:

1. A method of operating a low power wake-up signal radio (LR) implemented in a user equipment (UE), comprising:
determining that at least one criterion has been met; and
performing at least one measurement of a low power wake up signal (LP-WUS) when the at least one criterion has been met.

2. The method of claim 1, wherein a main radio (MR) is to perform at least one other measurement when the at least one criterion is not met or when at least one other criterion is met.

3. The method of claim 2, wherein the determining that the at least one criterion has been met includes:
receiving an indication from the MR that the at least one criterion has been met.

4. A method of operating a main radio (MR) implemented in a user equipment (UE), comprising:
determining that at least one criterion has been met; and
causing a low power wake-up signal radio (LR) to perform at least one measurement of a low power wake up signal (LP-WUS) when the at least one criterion has been met.

5. The method of claim 4, wherein the method includes:
performing at least one other measurement when the at least one criterion is not met or when at least one other criterion is met.

6. The method of claim 5, wherein the method includes:
sending an indication to the LR that the at least one criterion has been met.

7. The method of claim 6, wherein the at least one other measurement is a measurement of a synchronization signal block (SSB) or a channel state information reference signal (CSI-RS).

8. The method of claim 7, wherein the SSB is a non-cell defining (NCD) SSB or a cell defining (CD) SSB.

9. The method of claim 8, wherein the method includes:
activating the at least one measurement of the LP-WUS when the at least one criterion has been met; and
deactivating the at least one measurement of the LP-WUS when the at least one criterion has not been met or when the at least one other criterion is met.

10. The method of claim 9, wherein the method includes:
generating a report to indicate the activation or the deactivation of the at least one measurement of the LP-WUS; and
transmitting the report to a network access node (NAN).

11. The method of claim 10, wherein the method includes:
extending a measurement period for performing the at least one measurement when the measurement of the LP-WUS is activated.

12. The method of claim 11, wherein the method includes:
causing the LR to monitor for a paging signal when the at least one measurement of the LP-WUS is deactivated.

13. The method of claim 12, wherein the at least one other measurement is performed is a relaxed measurement when the at least one measurement based on LP-WUS is activated.

14. The method of claim 13, wherein the relaxed measurement includes a reduced measurement period for performing the at least one other measurement or a reduced number of measurement samples to be collected during a measurement period for performing the at least one other measurement.

15. The method of claim 14, wherein the at least one criterion includes one or more criteria selected from a group comprising: the UE being configured to perform LP-WUS measurement, the UE being in a low mobility condition, the UE being in a not-at-cell-edge condition, the UE being in a good serving cell quality condition, and the UE not being in a discontinuous reception (DRX) on duration.

16. The method of claim 15, wherein the at least one criterion includes one or more criteria selected from a group comprising: the at least one measurement being above or below a threshold, the at least one other measurement being above or below a threshold, a detection rate of the at least one measurement being above or below a threshold, a detection rate of the at least one other measurement being above or below a threshold, an error rate of the at least one measurement being above or below a threshold, an error rate of the at least one other measurement being above or below a threshold, a measurement of a serving cell being above or below a threshold, a measurement of a neighbor cell being above or below a threshold, an intra-frequency measurement being above or below a threshold, an inter-frequency measurement being above or below a threshold, a variation between at least two measurements being above or below a threshold, an average of measurements taken during a predefined or configured measurement period being above or below a threshold, a number of consecutive measurements being above or below a threshold, the UE being in a radio resource control (RRC) idle state, the UE being in an RRC inactive state, and the UE being in an RRC connected state.

17. The method of claim 16, wherein the at least one measurement is a radio resource management (RRM) measurement, a radio link monitoring (RLM) measurement, or a beam failure detection (BFD) measurement.

18. The method of claim 17, wherein the at least one measurement is a measurement of a serving cell, a measurement of at least one neighbor cells, an intra-frequency measurement, or an inter-frequency measurement.

19. The method of claim 18, wherein the at least one measurement based on LP-WUS includes at least one reference signal received power (RSRP) measurement, at least one reference signal received quality (RSRQ) measurement, at least one signal-to-noise ratio (SNR) measurement, or at least one signal-to-noise and interference ratio (SINR) measurement.

20-25. (canceled)
